(19) United States
(12) Patent Application Publication
(10) Pub. No.: US 2023/0382815 A1
(43) Pub. Date: Nov. 30, 2023

(54) NOVEL CONCRETE COMPOSITIONS WITH SELF HEALING PROPERTIES AND IMPROVED CONCRETE PERFORMANCE

(71) Applicant: Specification Products, Inc., Noblesville, IN (US)

(72) Inventors: William Archie Joseph Shetterley, Fortville, IN (US); Na Lu, West Lafayette, IN (US); Dustin A. Hartman, Boggstown, IN (US); Christopher Wolf, Carmel, IN (US)

(73) Assignee: Specification Products, Inc., Noblesville, IN (US)

(21) Appl. No.: 18/231,634

(22) Filed: Aug. 8, 2023

Related U.S. Application Data
(63) Continuation-in-part of application No. 18/114,214, filed on Feb. 24, 2023.
Application No. 18/114,214 is a continuation of application No. 17/569,269, filed on Jan. 5, 2022, now abandoned.
Application No. 17/569,269 is a continuation of application No. 16/501,232, filed on Mar. 8, 2019, now Pat. No. 11,279,658.
(60) Provisional application No. 63/396,118, filed on Aug. 8, 2022.
(60) Provisional application No. 62/761,064, filed on Mar. 9, 2018.
(60) Provisional application No. 62/761,393, filed on Mar. 22, 2018.
(60) Provisional application No. 62/765,597, filed on Sep. 1, 2018.

(30) Foreign Application Priority Data
Sep. 2, 2022 (CA) 3172454

(51) Int. Cl. C04B 40/00; C04B 7/36; C04B 14/06

(52) U.S. Cl. CPC C04B 40/0032; C04B 7/361; C04B 40/0039; C04B 14/06; C04B 14/062; C04B 2201/52; C04B 2111/60

(57) ABSTRACT

A method for the preparation of industrial-scale concrete installations with improved compression strength, curling, shrinking and cracking characteristics, the method comprising the addition of nanosilica particulate, and more preferably, colloidal amorphous silica, having specific size and surface area characteristics, to a concrete mix after water has been added to the mix and the mix has been agitated.

### PRIORITY AND RELATED APPLICATIONS

The present application a) is related to, and claims the priority benefit of, U.S. provisional patent application Ser. No. 63/396,118, filed Aug. 8, 2022, b) is related to, and claims the priority benefit of, Canadian patent application serial no. 3,172,454, filed Sep. 2, 2022, and c) is related to, claims the priority benefit of, and is a U.S. continuation-in-part patent application of, U.S. nonprovisional patent application Ser. No. 18/114,214, filed Feb. 24, 2023, which is related to, claims the priority benefit of, and is a U.S. continuation patent application of, U.S. nonprovisional patent application Ser. No. 17/569,269, filed Jan. 5, 2022, which is related to, claims the priority benefit of, and is a U.S. continuation patent application of, U.S. nonprovisional patent application Ser. No. 16/501,232, filed Mar. 8, 2019 and issued as U.S. Pat. No. 11,279,658 on Mar. 22, 2022, which is related to, and claims the priority benefit of, i) U.S. provisional patent application Ser. No. 62/765,597, filed Sep. 1, 2018, ii) U.S. provisional patent application Ser. No. 62/761,393, filed Mar. 22, 2018, and iii) U.S. provisional patent application Ser. No. 62/761,064, filed on Mar. 9, 2018. Each of the aforementioned patent applications are incorporated herein directly and by reference in their entirety.

### BACKGROUND

Concrete has been the basic element of construction since ancient times. Depending upon the type, concrete can have enough compressive strength to withstand the rigors of the elements and continuous public use with little structural degradation over time. Essential to its usefulness is the pourable rheology of water-containing mixtures of uncured concrete. Pourability of concrete enables structural shaping, such as for example, with a mold or other constraint, prior to curing into a hard form. Water functions in both the shaping and curing of concrete. However, heretofore, it has been necessary to carefully manage the water which gives rise to the pourability of concrete; too much or too little water in the concrete at any time during curing can negatively affect the concrete curing process, leading to a structurally compromised concrete product.

Water in curing concrete generally has three important functions. First, water is required for the hydration of the dry cement. The hydration reaction (curing) is the concrete-forming reaction (C-S-H forming reaction): water participates in a reaction by which the bonds are formed which give concrete its compressive strength. Theoretically, the concrete with the greatest compressive strength is formed when the hydration reaction goes to completion. In reality, the hydration reaction generally proceeds to a significant degree during the first stages of curing but is limited at later times by evaporation of water from the surfaces of the curing concrete. Concrete hydration can be greatly affected by ambient conditions such as wind speed, relative humidity and temperature. Thus, concrete can “dry” even though it is only partially cured. If the concrete surface dries out prematurely, hydration can be incomplete, giving a surface that is both porous and weak. In order for concrete to reach its full-strength potential, it is generally required that water be in place continuously for extended periods of time, often for days. In practice, concrete is seldom cured to its full-strength potential.

A second function of water is to aid in pourability of concrete. Upon the addition of water to the cement, but before hydration takes place on a large-scale, much of the water that will ultimately participate in hydration is already associated with the additives and calcium hydroxide in the concrete. Water in excess of this associated water generally benefits flowability of concrete, with more “extra” water generally correlating with a greater flowability of the concrete.

In general, it is thought in the industry that even relatively small amount of such extra water is detrimental to the concrete product. Environmental conditions (wind, relative humidity and temperature) can cause the surface of the slab to dry faster than the interior. Internal water is often trapped interiorly. A degree of hydration begins with the addition of water to the cement, and shortly after pouring, hydration can be well underway. The trapped water can escape to the surface through capillaries formed by the relatively dried, partially cured surface. The trapped water may instead form reservoirs inside the curing concrete, resulting in voids in the cured concrete product. Both capillaries and reservoirs can compromise the compression strength of the resultant cured concrete. They also enable environmental water to enter the concrete during its lifetime of service, allowing the concrete to be degraded by freeze damage and other water-mediated damage processes.

Furthermore, it is thought that water that does not participate in hydration (i.e., water that does not combine chemically with the concrete) essentially adds volume to the poured concrete, and the loss of this water during drying generally results in some degree of shrinkage of the concrete during curing. Nevertheless, the concrete must be workable. Thus, the inclusion of the optimum amount of water such that hydration (curing) and workability are maximized, while shrinkage and structural damage to the concrete during hydration/drying is minimized remains a delicate balancing act, made all the more difficult by environmental factors.

A third function of water is to enable finishing of partially cured surfaces which may also be desiccated due to evaporation. Surfaces which dry prematurely are generally difficult to finish. It is a normal practice to add water to such surfaces to facilitate strike-off, closing and finishing. Added water can penetrate the surface, particularly when capillaries are present. Such water generally leaves the concrete slowly over an extended period, often even when the concrete appears dry. Often further steps, such as sealing or steps which require securing components such as floor tiles or carpeting to the floor are affected by the slow release of finishing water. For example, it is not unusual for adhesives to fail within a short time of floor installation due to the slow emission of water. This water is often primarily finishing water. Even when water is added, the finishing machines often must be operated at higher settings in order to effectively finish a surface which has partially dried.

The use of additional cementitious materials in concrete to improve concrete properties, such as, for example, water impermeability, compressive strength and abrasion resistance, is well-known. Various types of particulate silica, such as, for example silica fume, have been used in concrete as additional cementitious materials to improve water-impermeability and compressive strength. A general problem with silica is that it can raise the water demand of a concrete formulation such that the likelihood of capillaries and void formation during curing is increased due to the higher likelihood of significant bleed water. To reduce bleed water, it is common in the art to use relatively large amounts of silica fume (5 to 10 percent by weight of cementitious materials), with water minimized or carefully rationed to relatively low amounts, such as, for example, below a ratio of about 0.5 by weight of water to cementitious materials. (Design and Control of Concrete Mixtures, Sixteenth Edition, Second Printing (revised); Kosmatka, Steven H.; pg. 156). Such low amounts of water are generally below what is recommended by the cement manufacturer, and can significantly impair the rheology of the concrete, causing it to be difficult to pour or work.

Concrete is inherently a brittle material and subjected to various types of internal stress induced by freeze-thaw cycles, shrinkage, large temperature fluctuation, and external traffic load. Damage is inevitable in the concrete structure. However, evidence has been found that the healing of the damaged concrete materials can restore the mechanical performance of the structure and prevent further corrosion. The service life of the concrete structure can then be elongated by the self-healing ability of the well-designed cementitious composite.

Various research has been done on improving the self-healing efficiency of the cementitious composite. It is believed that smaller cracks are much easier to completely heal than wider cracks. Therefore, fiber has been used to enhance the ductility of the concrete and control the crack propagation in the cementitious matrix. Different types of fiber have been evaluated by researchers, and it was found out that with the micromechanics design method, Polyvinyl alcohol (PVA) fiber had satisfying behavior in controlling the crack width.

To further improve the self-healing ability, supplementary cementitious materials (SCMs) were incorporated as they have low reactivity, which is more likely to remain un-hydrated at a later age and can be used for secondary hydration in the self-healing process. It is found that increasing the content of the SCMs, such as fly ash, can effectively reduce the crack width under tensile loading. However, it was also worth noting that the mechanical properties of the composite can be negatively affected by the low reactivity of the SCMs, especially at an early age.

Various technologies have been used in the evaluation of the self-healing of concrete, including resonant frequency and ultrasonic pulse velocity tests for evaluating the structural integrity of the concrete sample and quantifying the extent of healing. The healing process of the cracks has been monitored by optical microscope. Moreover, the scanning electron microscope (SEM) has been used for the observation and analysis of self-healing products.

As the concrete industry has continued to engage in the research and development of new technologies, nano materials have gradually been accepted in the design of the concrete mixture. Nanosilica powder has been used to enhance the bonding strength of the cementitious composite. Xu et al. incorporated titanium dioxide (TiO₂) nanoparticles and studied the tensile properties of the engineered cementitious composite. Nano limestone powder has also been used by Ding et al. in the engineered cementitious composite to improve mechanical performance. Among different types of nano particles that have been used in concrete, colloidal nanosilica (CNS) presents a unique feature that may be favorable for the self-healing of concrete materials. It has been found that a floc network would be formed as the CNS contact with alkaline cement pore solution. And, this physical network can slow down the diffusion of the moisture and other ions inside the concrete system. Evidence has been found that CNS could dramatically change the rheological properties of the concrete materials as the floc network blocks the water transition. Therefore, there is high potential that CNS can be used to improve the healing efficiency of the cementitious composite by holding part of the water in the floc network and using it for secondary hydration.

Before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### BRIEF SUMMARY

Surprisingly it has been found that the use, in poured concrete installations, of nanosilica (i.e., amorphous silica having particles with an average particle size of less than about 55 nm, and in some embodiments, less than about 7.8 nm, or, in other embodiments, between about 5 and about 55 nm, or between about 5 and about 7.9 nm; and having a surface area in the range of from about 300 to about 900 m²/g, or in other embodiments, from about 450 to about 900 m²/g, in amounts such that it is present in the concrete in a weight ratio in the range of from about 0.1 to about 4 ounces amorphous silica per 100 lbs of cement (i.e., not including water, aggregate, sand or other additives) can result in a significantly lower rate of water loss during curing than concrete which is hydrated in the absence of such amorphous silica. Thus, the surfaces of newly-poured, partially-cured concrete of the inventive method remain easily workable for longer periods than those of concrete prepared by other methods, and are less sensitive to environmental conditions which ordinarily speed evaporation. Bleed water, curling, cracking and shrinkage are generally greatly reduced. Compressive strength of the resultant cured concrete is generally significantly increased. Remarkably, important to the realization of the benefits of the invention is the introduction of nanosilica to the concrete mix after the water and other dry components have been mixed such that the dry components are thoroughly wetted. The introduction of nanosilica at an earlier stage, such as prior to the wetting, generally does not give a significant reduction in bleed water, cracking and shrinkage, and may in fact be worse in such aspects than controls without nanosilica. The foregoing holds true even if there is an improvement in compressive strength with respect to controls without nanosilica.

A concrete mixture is disclosed which comprises small-particle-size, high-surface-area amorphous nanosilica, used in much smaller proportions to the cement than generally used in the industry for structural purposes: only about 0.1 to about 4 ounces per hundred weight of cement mix (“cwt”). Higher amounts, such as about 1 to about 20 ounces per hundred weight of cement mix (“cwt”) are also within the scope of the present disclosure. In an additional aspect, the improved concrete mixtures are prepared by a process-specific addition of nanosilica. These improved concrete mixtures can be prepared using the standard amount of water recommended by the cement manufacturer, or even water in excess of the recommended amount, without significantly compromising compressive strength. Such a result is truly surprising. Despite the use of such water amounts, little or no bleed water is observed during curing. The formation of capillaries and voids is minimal or even essentially completely suppressed, and more water is retained in the concrete during curing, allowing more water to participate in curing over an extended period of time and compressive strength, both early (3 day) and particularly late (28 day), is greatly improved.

Despite their allowance for relatively high amounts of water, the low nanosilica concrete mixtures have improved compressive strength and abrasion resistance, among other improved characteristics. An improvement in compressive strength is surprising considering the small amounts of nanosilica employed, while known methods use much larger amounts to achieve gains which are, in some cases, significantly less. Furthermore, large improvements in concrete abrasion resistance have generally not been observed with the use of other types of silicas such as, for example, silica fume, even in the larger amounts usually used. (id, pg. 159). The low nanosilica concrete mixtures described herein give profound improvement in abrasion resistance as measured by ASTM C944. (Note that, with regard to the foregoing standard, the version employing a 22 pd, 98 kg load was used in all references to the standard herein.) Standard concrete mixtures (i.e., those not comprising the small-particle-size, high-surface-area amorphous nanosilica taught infra) can have a value of in the range of from about 2.5 to about 4.0 grams of loss. The low nanosilica concrete mixtures taught herein can have an ASTM C944 value as low as 1.1 grams of loss or less.

Even more remarkably, the specific steps of the process for mixing the components to form the cement mix are important for the realization of the increased water retention, compressive strength and workability of the newly poured, partially-cured concrete surfaces. Essentially all of the amorphous silica is added after the combination of some or essentially all water and the dry ingredients (for example, cement mix, aggregate, sand) within a mixing machine, such as, for example, a Ready-mix to be used in the mixing stage (i.e., prior to the actual pour). By “essentially all of the water,” it is meant that water which is part of the amorphous silica formulation, such as, for example, water involved in creating a colloidal suspension of the amorphous silica, generally being much less than the water added to the concrete mix, is not included within the meaning of “essentially all.” It is particularly convenient to add the small-particle-size silica after (or in some embodiments, with) a final portion of water (i.e., “tailwater”) prior to final mixing and pouring. The breaking of water addition into two portions is particularly convenient with the use of a Ready-mix in that the second portion can be used to rinse remnant dry components from near the mouth of the drum down into the bulk.

That small-particle-size silica is more effective after tailwater addition is unexpected. The general thinking in the art is that the addition of silica to concrete has heretofore been thought generally effective even if it is added to the mix of cementitious materials prior to the addition of water. However, it has been found on the scale required for construction of building slabs, footings and other large scale concrete pours, such that mixing and pouring equipment such as Ready-mixes are used, the addition of the small amount of small-particle-size silica, as described herein, has been demonstrated, as indicated herein, to be much more effective when added after the quantity of water, or, in preferred embodiments, with or after a second portion of water (“tailwater”) to concrete which has been wetted and, optionally, mixed for a period of time, as disclosed herein, than when it is added before the water, or with the portion of water used to wet the cementitious materials.

When the amorphous nanosilica is added after the water, cement mix and solids (aggregate and sand) are mixed, such as for example, with a Ready-mix or other mixer, the formation of capillaries and reservoirs within the poured concrete structure can be reduced or eliminated. The benefits of the invention can generally be obtained even when the concrete mix contains significant amounts of water in excess of that required by the cement manufacturer in order to fully hydrate the cement. Concrete mixtures having water equal to, or even in excess of, the amount required for full hydration, or recommended by the cement mix manufacturer, are preferred.

While nanosilica of larger sizes has been shown to improve compressive strength of concrete, it is well-known that nanosilica has a water requirement and as size is decreased and surface area is increased, the amount of water required by the concrete mixture increases. Thus, the perception in the art is that there is a tension between 1) decreasing silica particle size and 2) keeping water content low enough such that the formation of capillaries and voids are minimized. Thus, it is thought that at particularly small particle sizes, a risk exists that the water requirement would override the structural benefits provided by nanosilica. Illustrating this fact, the applicants have found that if the prescribed amorphous silica is added to the cement or concrete mix at other points in the preparation of the pourable concrete mixture, such as, for example, at any time prior to relatively complete mixing of water and cement mix (before or with the water which wets the cement mix), the resulting poured concrete can exhibit significantly more capillaries, voids and/or resulting surface bleed water than if the amorphous silica is added after complete mixing of the water and cement mix. Thus, it is surprising that if the silica is added (preferably as amorphous colloidal silica or precipitated silica) at a point after the cement and water have been completely mixed, the formation of capillaries and voids is reduced or eliminated, water evaporation is slowed, and newly poured, partially-cured surfaces are generally easily worked, even without the addition of finishing water. In general, it would be expected that some degree of benefit can be observed when the silica is added after the water even if complete mixing of the water and cement mix has not taken place.

The success of delayed addition of nanosilica is particularly surprising in light of what has been discovered about how factors such as nanosilica particle size and surface area affect concrete properties, most notably compressive strength, when introduced as colloidal nanosilica into concrete-forming mixtures. A summary of some findings in the art, the most recent findings of which the inventors only became aware after their own experimentation, is as follows. The use of colloidal nanosilica (silica having average particle sizes of less than about 100 nm, and particularly silica having average particle sizes of less than about 10-15 nm) in concrete-forming mixtures has been fraught with issues pertaining to compressive strength, among other properties, of the resulting concrete. For example, past studies have shown that larger particle-size silica, such as, for example, silica fume (about 145 nm) generally has a positive effect upon compressive strength in a wide range of particle sizes and loadings. However, smaller silica particles have a much more complicated correlation with compressive strength. Recent studies have shown that nanosilica particles tend to agglomerate in colloidal solutions. (Non-nano-sized silica particles, such as, for example, silica fume, have larger surface potentials, and are much less inclined to agglomerate.) The studies further show that such agglomerates, when introduced into concrete-forming mixtures and not subsequently sufficiently dispersed, such as, for example, by agitation, can become spaces in the final concrete product which are devoid of concrete matrix structure, negatively affecting compressive strength and other properties. However, the studies also show that the extensive surface area afforded by nanosilica for pozzolanic reaction, being much greater (by more than one order of magnitude, often several) than that of non-nano-sized silica, causes the C-S-H matrix-forming reaction to experience competition from reactions at the silica surface. As a result, the availability of a large amount of surface area can result in a weaker C-S-H matrix, resulting in lower compressive strength. Thus, in the search for nanosilica loading parameters which increase compressive strength, there can be a tension between 1) the persistence of aggregates in the concrete-forming mixture, and 2) agitation of the concrete-forming mixture or the application of other modes of dispersion, such that the aggregates are reduced or eliminated, but resulting in a surge in the amount of exposed silica surface area.

Setbacks were encountered in the inventor's attempts to use nanosilica in the field. It was found that silica loadings which clearly produce compressive strength gains in the lab when prepared by standard procedures such as ASTM 305-06 often failed to give compressive strength gains when used in standard fashion in a larger-scale process subject to the preparation constraints of an industrial pour, e.g. a Ready-mix process. Furthermore, the concrete was often rheologically compromised, having poor pourability, as well as often exhibiting greater bleed water, cracking, curing and shrinkage than a silica-free control.

Such a procedural dependence for the same loading levels of nanosilica could be considered unexpected because the apparent differences are in scale, as well as increased time to complete component mixing associated with the Ready-mix. One of skill in the art may not expect the processes which affect compressive strength to occur on the relatively brief timescale involved in the initial mixing of the concrete components, such that the differences in mixing times would affect compressive strength. This is especially true given that test cylinders are taken at pour time; i.e., differences in measured compressive strength could be argued to be not even partially attributable to the larger bulk size of a slab vs. the smaller size of a sample.

Furthermore, upon extensive experimentation, the addition of nanosilica late in the mixing process as described infra was found to restore the compressive strength-boosting effect of nanosilica. This was an unexpected result because much, if not almost all of the mixing agitation has taken place by the time the nanosilica is finally added. Thus, any aggregates are less likely to be completely dissipated into the concrete mix and would theoretically weaken the concrete as described above. In general, it has been found that on a construction scale, adding the colloidal nanosilica after the addition of mix water gives a concrete mixture which is more pourable and a concrete product of increased compressive strength, pourability, and wear resistance; as well as decreased cracking, curling and shrinking with respect to standard addition samples and silica-free control samples.

Various properties of the colloidal nanosilica-based strain-hardening cementitious composite (SHCC) were investigated. Specifically, mechanical properties and medium-term (three months) self-healing performance were evaluated through various testing methods. The essential mechanical behavior, including compressive, tensile, flexural, and bonding strength were assessed. The results indicated that the incorporation of colloidal nanosilica (CNS) can effectively improve the mechanical properties of SHCC, particularly, the compressive strength would rise 13% to 27%, and flexural strength can increase 7% to 9% with the CNS additional ratio of less than 1% by weight of cementitious materials. Both non-destructive and destructive testing methods were implemented to monitor the medium-term self-healing performance of SHCC with various CNS incorporation rates.

The SHCC samples were pre-cracked and placed under two different environmental conditions during the healing period. It has been suggested that the resonant frequency recovery ratio of nanosilica-based SHCC can recover 15% or above for 28 days under the wet-dry cycles conditions. Also, CNS-based SHCC can regain the resonant frequency of over 2% even under the low humidity condition. The tensile strength and stiffness retention results reveal that CNS can densify the SHCC matrix to achieve even higher tensile properties within one season (three months). The thermal gravity analysis and scanning electron microscope were conducted to understand the hydration conditions of each sample. It is summarized that the CNS incorporation rate between about 0.3% to about 0.6% would be the optimal ratio for SHCC to have remarkable mechanical properties and self-healing performance. The present disclosure therefore provides insight into the design of the high-performance cementitious composite with longer service life by enhancing the self-healing efficiency.

As such, the present disclosure includes disclosure of the investigation of the mechanical properties and self-healing performance of the designed cementitious composite with the incorporation of various content of CNS. First, the mechanical performance of the designed material is examined by compressive, flexural, and tensile tests. The ductility of the prepared sample is also evaluated. Then, the drying shrinkage measurement and bonding strength testing was conducted to further understand the influence of the colloidal nanosilica on the behavior of the designed composite. Next, dog-bone samples were pre-loaded by the uniaxial tensile test and subjected to wet/dry cycles for self-healing. Along the medium-term (three months) healing period, the healing efficiency of the pre-damaged sample is evaluated by the resonant frequency measurement. The sealing of cracks is observed and analyzed by optical microscope and Image J. Finally, the hydration of the designed material and its microstructure are investigated by the thermogravimetric analysis (TGA) and scanning electron microscope (SEM).

In at least one embodiment of a method for preparing a concrete mixture of the present disclosure, the method comprises a) combining a quantity of dry cement mix, a first quantity of water, and a quantity of sand and/or aggregate and mixing the same until they are fully mixed and wetted (or nearly fully wetted), forming a mixed and wetted combined product, and b) adding a quantity of amorphous nanosilica to the mixed and wetted combined product and mixing the same to form a concrete mixture, wherein the quantity of amorphous nanosilica is either i) added to the mixed and wetted combined product along with a second quantity of water, or ii) a colloidal nanosilica suspension that is added to the mixed and wetted combined product to form the concrete mixture.

In at least one embodiment of a method for preparing a concrete mixture of the present disclosure, steps a) and b) are performed by mixing the quantity of dry cement mix, the first quantity of water, the quantity of sand and/or aggregate, and the quantity of amorphous nanosilica within a drum of a ready-mix concrete truck.

In at least one embodiment of a method for preparing a concrete mixture of the present disclosure, wherein the drum of the ready-mix concrete truck is rotating at or between about 12 rpm and 20 rpm.

In at least one embodiment of a method for preparing a concrete mixture of the present disclosure, step a) is performed by also combining a quantity of fly ash with the quantity of dry cement, the first quantity of water, and the quantity of sand and/or aggregate to form the mixed and wetted combined product.

In at least one embodiment of a method for preparing a concrete mixture of the present disclosure, the method further comprises the step of combining a viscosity-modifying admixture with an additional quantity of water to form an admixture part and adding the admixture part to the mixed and wetted combined product prior to performing step b).

In at least one embodiment of a method for preparing a concrete mixture of the present disclosure, the method further comprises the step of adding a polyvinyl alcohol fiber or other fiber reinforcement material to the mixed and wetted combined product prior to performing step b).

In at least one embodiment of a method for preparing a concrete mixture of the present disclosure, the concrete mixture can be poured and cured to form a hardened concrete product.

In at least one embodiment of a method for preparing a concrete mixture of the present disclosure, a crack having a width of about 30 μm or less formed within the hardened concrete product can seal after exposing the hardened concrete product to at least two wet/dry cycles.

In at least one embodiment of a method for preparing a concrete mixture of the present disclosure, the concrete mixture is formed without the use of any supplementary cementitious materials, any water-reducer, any superplasticizer, or other admixture chemical. Furthermore, no pre-processing of nanosilica is required, such as via sonication or other dispersion means, prior to placement into a concrete mix.

In at least one embodiment of a method for preparing a concrete mixture of the present disclosure, the amorphous nanosilica is present in a range of about 0.1 ounces to about 50 ounces per 100 pounds of cement.

In at least one embodiment of a method for preparing a concrete mixture of the present disclosure, the amorphous nanosilica has an average particle size in the range of about 1 nanometer to about 150 nanometers.

In at least one embodiment of a method for preparing a concrete mixture of the present disclosure, the amorphous nanosilica has a surface area in the range of about 40 m²/g to about 1200 m²/g.

In at least one embodiment of a method for preparing a concrete mixture of the present disclosure, the amorphous nanosilica is selected from the group consisting of colloidal nanosilica, precipitated silica, silica gel, and fumed silica.

In at least one embodiment of a method for preparing a concrete mixture of the present disclosure, the amorphous nanosilica is provided as a colloidal nanosilica suspension comprising up to about 50 wt % amorphous silica.

In at least one embodiment of a method for preparing a concrete mixture of the present disclosure, the amorphous nanosilica is provided as a colloidal nanosilica suspension comprising about 15 wt % amorphous silica in about 85 wt % water.

In at least one embodiment of a method for preparing a concrete mixture of the present disclosure, the colloidal nanosilica suspension is present within the concrete in a range of about 1 ounce to about 20 ounces per 100 pounds of cement.

In at least one embodiment of a method for preparing a concrete mixture of the present disclosure, the amorphous nanosilica has an alkaline pH above 7.

In at least one embodiment of a concrete mixture of the present disclosure, said concrete mixture is prepared by a) combining a quantity of dry cement mix, a first quantity of water, and a quantity of sand and/or aggregate and mixing the same until they are fully mixed and wetted (or nearly fully wetted), forming a mixed and wetted combined product, and b) adding an amorphous nanosilica to the mixed and wetted combined product and mixing the same to form a concrete mixture;

In at least one embodiment of a concrete mixture of the present disclosure, the amorphous nanosilica is added to the mixed and wetted combined product along with a second quantity of water.

In at least one embodiment of a concrete mixture of the present disclosure, the amorphous nanosilica is first combined with a quantity of liquid to form a colloidal nanosilica suspension (amorphous colloidal silica) that is added to the mixed and wetted combined product to form the concrete mixture.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a graph of the particle size distribution of silica sand, according to an exemplary embodiment of the present disclosure.

FIG. 2 shows a transmission electron microscopy (TEM) image for colloidal nanosilica, according to an exemplary embodiment of the present disclosure.

FIG. 3A shows a setup of a direct tensile test, according to an exemplary embodiment of the present disclosure.

FIG. 3B shows a setup of a four-point bending test, according to an exemplary embodiment of the present disclosure.

FIG. 4A shows a pull-off large sample, according to an exemplary embodiment of the present disclosure.

FIG. 4B shows a pull-off tester, according to an exemplary embodiment of the present disclosure.

FIG. 5 shows the steps of an experimental procedure of self-healing evaluation with colloidal nanosilica, according to an exemplary embodiment of the present disclosure.

FIG. 6 shows a setup of a resonance frequency test, according to an exemplary embodiment of the present disclosure.

FIG. 7 shows a chart of compressive strength results based upon colloidal nanosilica (CNS) content, according to an exemplary embodiment of the present disclosure.

FIG. 8 shows four-points flexural test results, according to an exemplary embodiment of the present disclosure.

FIG. 9A shows flexural stress-deflection curves of strain-hardening cementitious composite (SHCC) samples at 7 days, according to an exemplary embodiment of the present disclosure.

FIG. 9B shows flexural stress-deflection curves of SHCC samples at 28 days, according to an exemplary embodiment of the present disclosure.

FIG. 10 shows the calculation of the ductility index for the SHCC sample, according to an exemplary embodiment of the present disclosure.

FIG. 11 shows tensile strength results of SHCC samples, according to an exemplary embodiment of the present disclosure.

FIG. 12 shows drying shrinkage results of SHCC-E5, according to exemplary embodiments of the present disclosure.

FIG. 13 shows bond strength results of SHCC-E5 CNS, according to exemplary embodiments of the present disclosure.

FIG. 14 shows the results of a resonant frequency test (SHCC exposed to a wetting/drying (W/D) cycle), according to an exemplary embodiment of the present disclosure.

FIG. 15 shows the results of a resonant frequency test (SHCC exposed to 50% relative humidity (RH) dry condition), according to an exemplary embodiment of the present disclosure.

FIG. 16A shows a chart of the results of tensile strength retention ratio (SHCC exposed to W/D cycles), according to an exemplary embodiment of the present disclosure.

FIG. 16B shows a chart of the results of tensile stiffness retention ratio (SHCC exposed to W/D cycles), according to an exemplary embodiment of the present disclosure.

FIG. 17A shows tensile strength retention ratio test results (SHCC exposed to dry conditions), according to an exemplary embodiment of the present disclosure.

FIG. 17B shows tensile stiffness retention ratio test results (SHCC exposed to dry conditions), according to an exemplary embodiment of the present disclosure.

FIG. 18 shows representative microscope images for same (0.3% E5 SHCC) after preloaded and two W/C cycles, according to an exemplary embodiment of the present disclosure.

FIG. 19 shows the results of the average crack recovery ratio for SHCC under W/D cycle curing condition, according to an exemplary embodiment of the present disclosure.

FIG. 20 shows the probability of SHCC crack width after a three-points bending test, according to an exemplary embodiment of the present disclosure.

FIG. 21 shows the calcium hydroxide (CH) content of various samples after self-healing conditioning, according to exemplary embodiments of the present disclosure.

FIG. 22 shows a chart of chemically bonded water and tensile stiffness retention ratios of various SHCC samples, according to exemplary embodiments of the present disclosure.

FIG. 23A shows a SEM image for a reference SHCC specimen (after 21 W/D cycles), according to an exemplary embodiment of the present disclosure.

FIG. 23B shows a SEM image for a 0.3% E5 SHCC specimen (after 21 W/D cycles), according to an exemplary embodiment of the present disclosure.

FIG. 23C shows a SEM image for a 0.6% E5 SHCC specimen (after 21 W/D cycles), according to an exemplary embodiment of the present disclosure.

FIG. 23D shows a SEM image for a 1% E5 SHCC specimen (after 21 W/D cycles), according to an exemplary embodiment of the present disclosure.

FIG. 24 shows a chart of an average area of un-hydrated cementitious materials of different SHCC samples, according to exemplary embodiments of the present disclosure.

FIG. 25 is a summary of experimental results taken in accordance with the procedure described in Example 3 and referred to in the analysis presented therein, according to exemplary embodiments of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A concrete mix of the present disclosure is created from components comprising quantities of a) a dry cement mix; b) water; c) amorphous silica; and d) aggregate and/or sand.

Dry cement mixes generally have a recommended water content which gives a water/cement ratio providing a concrete mix which has a combination of desirable pouring and curing characteristics. In some cases, the recommended water content encompasses a range of water contents. As indicated infra, the initial water content of concrete mix prior to pouring can give rise to issues during curing and finishing which reduce the quality of the resulting concrete installation (slab, footing, etc.). It is common for water-reducing measures, such as the use of “water-reducers” and superplasticizers to be employed in the interests of reducing water-mediated structural flaws in the cured concrete. It should be noted that while the benefits of the present invention should be evident in circumstances in which the water content is being reduced below that recommended by the manufacturer, the present invention can be used to give the inventive concrete in situations in which the water included in the concrete mix is equal to or greater than the amount specified by the manufacturer of the dry cement mix. Water-reducers in the concrete mix are generally unnecessary.

Thus, in a broad aspect, the cement mix and the water present in the concrete mix are present in the mix in the following proportions:
A quantity of water; and a quantity of dry cement mix, said cement mix characterized by:
i) a manufacturer suggested water/cement ratio value; wherein said suggested ratio falls in the range of from about 0.35 to about 0.65; and whereupon combination with the quantity of water, the water/cement ratio is greater than the value corresponding to about 10% less than the suggested value but less than the value corresponding to about 30% more than the suggested value;
   or
ii) a manufacturer suggested water/cement ratio range, having an upper value and a lower value, and whereupon combination with the quantity of water, the water/cement ratio is greater than the value corresponding to about 10% less than the lower value and not greater than the value corresponding to about 30% more than the upper value;
   or
iii) an amount such that, whereupon combination with the quantity of water, the water/cement ratio is in the range of from about 0.35 to about 0.65;

The benefits of the invention are generally expected to be manifest with the use of commercially useful types of Portland cement. The cement mix is one or more of the types commonly used in construction, such as, for example, Portland cements of Types I, II, III, IV and V, Portland limestone cement (PLC, also referred to as Type 1L cement), and others.

The quantity of water above is added to the cement mix. This quantity is inclusive of all water which is combined with the concrete mix comprising at least the cement mix, except water introduced with the silica in the case of water-containing formulations such as colloids, dispersions, emulsions, and the like. As further detailed below, the water can be combined with the concrete mix comprising at least the cement mix in multiple portions, such as, for example, the addition of a second portion of water (for example, “tailwater”) after a first portion of water has been combined with the concrete mix and agitated for a time. Note that water is sometimes applied to the surface of concrete after it has partially cured, to prevent the premature drying of the surface, which could result in shrinkage, as well as later difficulties in working and finishing. This “finishing” water is not included within the quantity of water. In other embodiments, the water/cement ratio is in the range of from about 0.38 to about 0.55, or, in more specific embodiments, in the range of from about 0.48 to about 0.52, or in the range of from about 0.38 to about 0.42.

In a more preferred embodiment, in reference to i), ii), and iii), above, the water and cement mix are present in the concrete mix in the proportions wherein upon combination of the quantity of dry cement mix with the quantity of water, the water/cement ratio is:
equal to or greater than the suggested value, but not greater than the value corresponding to 30% more than the suggested value; or
equal to or greater than the upper value of the suggested range, but not greater than the value corresponding to about 30% more than the upper value; or at least 0.35, but not greater than 0.65.

Particle size of amorphous silica is particularly important. Larger particle sizes, such as will be found in micronized silica, generally do not reduce the formation of capillaries and voids to the degree seen when amorphous silica sized as prescribed herein is used in the prescribed amounts. The inventive concrete mix comprises a quantity of amorphous nanosilica, which can be present in the range of about 0.1 to about 20 or even about 50 ounces per hundredweight of cement (cwt), is preferably present in an amount in the range of from about 0.1 to about 7.0 ounces per hundredweight of cement (cwt) in a), and having particle sizes such that the average silica particle size is in the range of from about 1 to about 150 nanometers, preferably in the range of about 1 to about 55 nanometers, and/or wherein the surface area of the silica particles is in the range of from about 300 to about 900 m²/g, or in other embodiments, from about 450 to about 900 m²/g.

Amorphous silica from various sources is generally suitable as long as it is characterizable by the particle size and surface area parameters above. Nonlimiting examples of suitable amorphous silica include colloidal silica, precipitated silica, silica gel and fumed silica. However, colloidal amorphous silica and silica gel are preferred, and colloidal amorphous silica is most preferred.

In further embodiments, the silica particle size is in the range of from about 5 to about 55 nm. Preferred are particles with average particle size of less than about 25 nm, with average particle size of less than about 10 nm more preferred, and average particle size of less than about 7.9 nm even more preferred. A preferred weight proportion in the concrete is from about 0.1 to about 3 ounces of amorphous silica per 100 lbs of cement (not including water, aggregate, sand or other additives). A more preferred weight proportion in the concrete is from about 0.1 to about 1 ounces of amorphous silica per 100 lbs of cement (again, not including water, aggregate, sand or other additives). Even more preferred is about 0.45 to about 0.75 ounces of amorphous silica per 100 lbs of cement (again, not including water, aggregate, sand or other additives). Surprisingly, above about 3 to about 4 ounces of the amorphous nanosilica per 100 lbs cement mix, the concrete mix can become difficult to pour or work, and compressive strength can suffer greatly, even with respect to non-silica controls. Otherwise, amounts above about 1 ounce per 100 lbs cement generally give decreasing compressive strength gains with respect to the preferred range of about 0.45 to about 0.75 ounces of amorphous silica per 100 lbs cement. The preferred range given is the most economically feasible range, i.e., above that, the compressive strength gains are less per additional unit of silica, and cost of silica per unit increase of compressive strength may cause the cost of the concrete to become prohibitive.

Amorphous silicas having surface areas in the range of from about 40 to about 1,200 m²/gram, whereby about 50 to about 900 m²/gram are preferred, with about 150 to about 900 m²/gram more preferred, and about 400 to about 900 m²/gram even more preferred, and 450-700 m²/gram or 500-600 m²/gram even more preferred. Amorphous silica with an alkaline pH (about pH 7 and above) is preferred, with a pH in the range of from 8 to 11 being more preferred.

In yet another embodiment, the amorphous silica is provided by the use of E5® INTERNAL CURE®, an additive available commercially from Specification Products, Inc., which contains about 15 wt % amorphous silica in about 85 wt % water. Various colloidal nanosilica products of the present disclosure can have up to about 50 wt % amorphous silica in about 50 wt % fluid (such as water). The silica particle characteristics are an average particle size of less than about 10 nm (measured by BET method), and a surface area of about 550 m²/g. In one embodiment, the weight proportion of E5 INTERNAL CURE to cement is in the range of from about 1 to about 20 ounces of E5 INTERNAL CURE to 100 lb cement (not including water, sand, aggregate or other additives). More preferably, the weight proportion of E5 INTERNAL CURE to cement is in the range of from about 1 to about 10 ounces of E5 INTERNAL CURE to about 100 lb cement (not including water, sand, aggregate or other additives). A more preferred weight proportion of E5 INTERNAL CURE to cement is in the range of from about 1 to about 5 ounces of E5 INTERNAL CURE to about 100 lb cement, with about 3 to about 5 ounces of E5 INTERNAL CURE to about 100 lb cement (not including water, sand, aggregate, or other additives) even more preferred. Surprisingly, the use of more than about ounces of E5 to about 100 lb cement (again, not including water sand, aggregate or other additives) can cease to be of benefit in that additional beneficial water or compressive strength benefits may not be observed or may be minimally observed. The resulting concrete mix may be difficult to pour, and any resulting concrete may be of poor quality. Note that the quality of the concrete diminishes with the distance from the preferred range of about 3 to about 5 ounces per 100 lb cement, but the compressive strength may still be improved over that in the absence of E5 INTERNAL CURE. In preferred embodiments, the colloidal nanosilica added to the concrete mix is in the range of from about 2 to about 60 wt % silica (40 to about 98 wt % water and/or other liquid), with about 5 to about 40 wt % silica preferred (about 60 to about 95 wt % water and/or other liquid preferred) and about 8 to about 30 wt % silica more preferred (about 70 to about 92 wt % water and/or other liquid more preferred), and about 10 to about 25 wt % silica even more preferred (about 75 to about 90 wt % water and/or other liquid) even more preferred.

Aggregate and sand can generally be used in the inventive concrete in amounts as known in the art for construction purposes. In one embodiment, a quantity of aggregate and/or a quantity of sand is used such that they total an amount in the range of from about 400 to about 700 wt % bwoc. In general, a concrete mix is prepared with components comprising cement, water, and, preferably, a quantity of aggregate and sand (sometimes referred to in the art as “large aggregate” and “small aggregate,” respectively). It is permissible for the concrete mix to comprise only one of the two, such as only sand or only aggregate, but it is preferred the mix comprise at least a quantity of each. Sand and aggregate can contribute to the silica content of the cement mixture, and thus they can affect (i.e., raise somewhat) the water requirement of the concrete mix. Generally, most types of aggregate which are appropriate for the use to which the concrete is to be put can be used. Included are larger aggregates such as coarse, crushed limestone gravel, larger grades of crushed clean stone, and the like, as well as smaller aggregates such as the smaller grades of crushed clean stone, fine limestone gravel, and the like. Likewise, many types of sand, such as pit (coarse) sand, river sand and the like can be used. Generally, in concrete applications, “coarse sand” is preferred to “soft sand,” which is known to be more appropriate for use in mortars. However, soft sand may generally be expected to have a different water requirement than coarse sand when used in concrete preparation. As is known in the art, weight-bearing applications may require larger aggregate, such as coarse, crushed limestone. Such larger aggregate is preferred for poured concrete applications, particularly for use in poured building slabs, such as, for example, coarse crushed limestone gravel and larger grades of crushed clean stone, and pit sand.

The proportion of aggregate and sand, taken together, based on weight of cement (bwoc) is preferably in the range of from about 2000 to about 4000 lbs per yard of dry cement mix (in the range of from about 520 to about 610 lbs per yard, or more preferably from about 560 to about 570 lbs per yard, even more preferably, about 564 lbs per yard). More preferred is a combined proportion of aggregate and sand in the range of from about 2700 to about 3300 lbs per yard of dry cement mix. More preferred is a range of from about 2900 to about 3100 lbs per yard of dry cement mix. In another embodiment, the weight of aggregate and sand is between 50 and 90 wt % based upon the weight of the concrete, with a range of from about 70 to about 85 wt % preferred. The relative amounts of aggregate and sand are not critical but are preferably in the range of from about 20 wt % to about 70 wt % sand based upon the combined weight of the sand and aggregate, with about 40 wt % to about 50 wt % sand preferred.

It has been discovered, especially in commercial scale pours, that even the small amounts of amorphous nanosilica required to effect the disclosed benefits, when added to the concrete mix prior to the water, can be detrimental to the pourability of the concrete mix, as well as the quality of the resultant concrete, even rendering the concrete unsuitable. The process of the present invention generally includes the situation in which at least a portion of the quantity of water is added prior to the addition of the quantity of amorphous nanosilica, with at least a time period of agitation between the additions to distribute the water prior to the addition of the amorphous silica. In practice, some water may be added later in the preparation process, if desired. For example, it is known to add water in two (or more) portions, such as the practice of adding a portion as “tailwater” after the addition and agitation of a first portion. In one embodiment, the amorphous nanosilica is added as a colloidal nanosilica with a second portion of water. In a preferred embodiment, the colloidal silica is added after the addition of water which has been added in two portions, with agitation after the addition of each portion. Thus, more generally, the quantity of water can be added in its entirety or added in portions comprising an initial portion, comprising in the range of from about 20 wt % to about 95 wt % of the quantity of water, and a tailwater portion, comprising the remainder; wherein the initial portion of water is combined with the quantity of cement mix and the aggregate/sand components to form a first mix; and wherein the amorphous silica is added to a mix comprising the quantity of cement mix, the aggregate/sand components and the initial portion of water to form a second mix. Even more preferred is an initial portion comprising in the range 35 to about 60 wt % of the quantity of water. (The below three situations (i.e., “situation 1”, “situation 2” and “situation 3”) correspond, respectively to i) the addition of the silica after the addition of the tailwater; ii) the addition of the silica before the addition of the tailwater; and iii) the co-addition of the silica with the tailwater.)

In embodiments with split water addition, wherein the tailwater is 1) added to the first mix; or 2) added to the second mix; or 3) co-added with the amorphous silica to the first [second?] mix, wherein the amorphous silica and the tailwater are, optionally, intercombined; and wherein 1) the first mix is agitated for a time t₁₁ prior to the addition of the tailwater, for a time t₁₂ after the addition of the tailwater but before the addition of the amorphous silica, and for a time t₁₃ after the addition of the amorphous silica; or 2) the second mix is agitated for a time t₂₁ prior to the addition of the amorphous silica, for a time t₂₂ after the addition of the amorphous silica but before the addition of the tailwater, and for a time t₂₃ after the addition of the tailwater; or 3) the second mix is agitated for a time t₃₁ prior to co-addition of the amorphous silica and the tailwater, and whereupon the concrete mix is then agitated for a time t₃₂.

In situation 1), in which the second portion of water (tailwater) is added to a concrete mix comprising a first portion of water, the quantity of cement and the sand/aggregate components, t₁₁ is preferably in the range of from about 2 to about 8 minutes, with about 3 to about 6 minutes more preferred, and at a mixing speed (such as for example, in a Ready-mix) preferably in the range of from about 2 to about 5 rpm. Time t₁₂ is preferably in the range of from about 0.5 to about 4 minutes, with a more preferred range of from about 1 to 2 minutes, at a mixing speed in the range of from about 2 to about 5 rpm. Time t₁₃ is preferably in the range of from about 2 to about 10 minutes, with a range of from about 5 to about 10 minutes more preferred, with a relatively high mixing speed at a rate in the range of from about 12 to about 15 rpm. After the high rate mixing, the rate can be lowered to a rate in the range of from about 2 to about 5 rpm for a time, such as, for example, a transit time to a pour site. Transit time standards are set by the American Concrete Institute. For example, the concrete must be poured within 60 minutes of the end of high-rate mixing if the temperature is 90 F or greater, and within 90 minutes if the temperature is less than 90 F.

In situation 2), in which the second portion of water (tailwater) is added to a concrete mix comprising a first portion of water, the quantity of cement and the sand/aggregate components, and the amorphous silica, t₂₁ is preferably in the range of from about 2 to about 8 minutes, with about 3 to about 6 minutes more preferred, and at a mixing speed (such as for example, in a Ready-mix) preferably in the range of from about 2 to about 5 rpm. Time t₂₂ is preferably in the range of from about 0.5 to about 2 minutes, with a more preferred range of from about 0.5 to 1 minutes, at a mixing speed in the range of from about 2 to about 5 rpm. Time t₂₃ is preferably in the range of from about 2 to about 10 minutes, with a range of from about 5 to about 10 minutes more preferred, with a relatively high mixing speed at a rate in the range of from about 12 to about 15 rpm. After the high-rate mixing, the rate can be lowered to a rate in the range of from about 2 to about 5 rpm for a time, such as, for example, a transit time to a pour site. As noted above, transit time standards are set by the American Concrete Institute.

In situation 3), in which the tail water is co-added with the amorphous silica to the first mix, wherein the amorphous silica and the tailwater are, optionally, intercombined, t₃₁ is preferably in the range of from about 2 to about 8 minutes, with about 3 to about 6 minutes more preferred, and at a mixing speed (such as for example, in a Ready-mix) preferably in the range of from about 2 to about 5 rpm. Time t₃₂ is preferably in the range of from about 2 to about 10 minutes, with a range of from about 5 to about 10 minutes more preferred, with a relatively high mixing speed at a rate in the range of from about 12 to about 15 rpm. After the high-rate mixing, the rate can be lowered to a rate in the range of from about 2 to about 5 rpm for a time, such as, for example, a transit time to a pour site. As noted above, transit time standards are set by the American Concrete institute.

In another embodiment, the entire quantity of water is added to the quantity of cement and the aggregate/sand components to form a mix, whereupon said mix is agitated for a time tₐ prior to the addition of the amorphous silica, whereupon the concrete mix is then agitated for a time t_{b} prior to pouring. The addition of the entire quantity of water at once is useful in the case of wet batch processes. Time tₐ is preferably in the range of from about 2 to about 8 minutes, with about 3 to about 6 minutes more preferred, and at a mixing speed (such as for example, in a Ready-mix) preferably in the range of from about 2 to about 5 rpm. Time t_{b} is preferably in the range of from about 2 to about 10 minutes, with a range of from about 5 to about 10 minutes more preferred, with a relatively high mixing speed at a rate in the range of from about 12 to about 15 rpm. After the high-rate mixing, the rate can be lowered to a rate in the range of from about 2 to about 5 rpm for a time, such as, for example, a transit time to a pour site. As noted above, transit time standards are set by the American Concrete Institute. While benefits of the invention would generally be observed in the case of a single addition of water, in practice, the two-portion division of water is generally adhered to. After the agitation of a concrete mix comprising a first portion, the use of a second portion has the advantage of washing down into the Ready-mix remnants of insufficiently mixed cement mix from near the mouth of the barrel.

The concrete mixture can be prepared in a wet (“central mix”) or dry (“transit mix”) batch situation. In wet batch mode, the dry components are mixed with the quantity of water followed by the amorphous silica to give a concrete mix, in one of the ways indicated above. The mix is agitated as above or introduced into a Ready-mix and agitated therein as indicated above. Essentially, the wet and dry batch situations are similar except that part of the procedure for a wet batch is performed outside of the Ready-mix truck (for example, at the plant). Dry batching (“transit mix”) is somewhat preferred. For example, 40 plus or minus 20%, or, in further embodiments, plus or minus 10% of the total quantity of water to be utilized in the preparation of the concrete mix, sand and coarse aggregate used in the batch is loaded into a Ready-mix. The cement mix, coarse aggregate and sand are mixed together and loaded into the Ready-mix. The remaining water is then loaded into the Ready-mix. Once the dry components and the water are completely mixed, the amorphous silica is added, and the mixture is mixed for 5 to 10 minutes. The mixing preferably takes place at relatively high drum rotation speeds, such as, for example, a speed in the range of from about 12 to about 15 rpm. Once the higher-speed mixing has occurred, the batch can then be poured. However, it is permissible to have a period of time between the higher-speed mixing and pouring, such as transport time to the pouring site. In general, as long as the concrete is mixed at lower speeds, such as, for example, about 3 to about 5 rpm, a time between the high-speed mixing and the pouring of in the range of from about 1 to about 60 minutes is permissible.

In one embodiment, it is particularly convenient to add the silica to a Ready-mix, which contains the water, cement and other dry components, once the Ready-mix has arrived at the pour site. It has further been found that after the amorphous silica has been added, the concrete/silica mixture should be mixed, prior to pouring, for a time, most preferably at least from about 5 to about 10 minutes. However, other periods of time may be permissible with respect to at least partially obtaining the benefits of the invention.

The benefits of the invention can be expected in commercially used variants of the foregoing process, as long as the amorphous silica is added at the end, after the mixing together of the dry components and the first and second portion of water (or with the second portion of water), and the silica-added mixture is mixed for a time as specified herein prior to pouring.

The concrete mix is then poured to form a concrete installation. In a preferred embodiment, the concrete mix is formed and agitated in the context of an industrial scale pour, such as the preparation of footings or slabs. In an additional embodiment, the concrete mix is created with and within equipment which holds the mix as it is being created, and which also has the capacity to agitate the mix, such as, for example, a Ready-mix. One advantage of the present inventive process is that water in concrete formation, such as for example, a slab, formulated according to the present invention, appears to be immobilized in the formation rather than lost to evaporation. The likely fate of much of this water is to participate in hydration at extended periods of time rather than form capillaries and voids. Thus, it is expected that, regardless of thickness, concrete slabs, walls and other formations will display a reduction or lack of voids and capillaries, and a correlative gain in compressive strength. Concrete formation having improved structure and compressive strength with thicknesses up to about 20 feet can be formed with the concrete of the present invention.

An advantage of the present inventive process is that poured concrete is less damaged by drying caused by environmental conditions, such as temperature, relative humidity and air motion such as wind. For example, concrete of good quality can be produced at wind speeds as high as 50 mph, temperatures as high as 120° F. and as low as 10° F., and relative humidities as low as 5% and as high as 85% or even higher.

The compressive strength of the concrete formed by the method of the present invention is generally increased with respect to concrete formed by methods which are similar or, preferably, the same save for the addition of silica after the mixing of the water, cement mix and filler materials (aggregate, sand and the like). “Similar” or “the same” applies to environmental conditions such as wind speed, relative humidity and temperature profile, as well as other environmental factors, such as shading or heat radiating surroundings with respect to the assessment of increase in compressive strength. Factors within the pourer's control, such as mixing times and parameters, pouring parameters (i.e., slab dimensions) are more easily accounted for. An increase in compressive strength is preferably assessed from pours which are identical except for the addition of the amorphous silica. In a preferred embodiment, the assessment is made from pours which are prepared from identical amounts of identical ingredients, simultaneously but in separate Ready-mixes, poured side-by-side, at the same time, but using separate Ready-mixes. Such pours are “substantially identical.”

The increase in compressive strength can be in the range of from about 5 to about 40% or even more, based upon the compressive strength of the non-silica-containing pour of a pair of substantially identical pours. In more commonly observed embodiments, the compressive strength increases as assessed through substantially identical pours is in the range of from about 10 to about 30%.

The concrete of the present invention can generally be used in applications which require poured concrete, such as, for example, slabs, footings, and the like. An advantage of the present invention is that the concrete prepared therefrom is generally of increased resistance to water penetration and can thus be used in poured applications which are particularly prone to moisture exposure and the associated damage, such as footings.

As indicated infra, the present invention involves the discovery that nanosilica, when added to a concrete mix, preferably as a colloidal silica, after the addition of at least a portion of water, gives a concrete having an improved compressive strength among other improved properties, such as abrasion resistance and water permeability.

The additive concrete components such as sand and aggregates of sizes which are used in the art can generally be used in the concrete of the present invention without destroying the benefits provided by the present invention.

Thus, it is possible to utilize a concrete, comprising of ample water for hydration, pouring and working, in the preparation of concrete which generally lacks the deficiencies otherwise associated with concrete from concrete having high amounts of water of transport. The inventive compositions result in concrete which retains water such that exposed surfaces are less likely to dry prematurely than concrete which have not had amorphous silica added. The relative water retention effect is observed even in ambient conditions under which the surface would ordinarily be predisposed to desiccate. Concrete can thus be poured under a broader range of environmental conditions than standard concrete. Surfaces can thus be finished with reduced amounts of surface water, or even, in some cases, without adding surface water.

Remarkably, shrinkage is reduced with respect to concrete containing comparable amounts of water. More remarkably, the compressive strength is increased. This result is generally obtained even though the concrete contains amounts of water of transport that would risk capillary and void formation in absence of amorphous silica.

Without desiring to be bound by theory, it is surmised that the amorphous silica may immobilize the water during curing such that the water is prevented from migrating, retarding evaporation as well as capillary and void formation. Surprisingly, the immobilization does not prevent the water from participating in long term, extended hydration, which gives the unexpected increase in compressive strength.

An overarching benefit of the present invention is the ability not to use excess water in the curing reaction (hydration) due to generally losing the water to evaporation. Such a benefit can be obtained even in the case of concrete which are poured having water levels which are less than theoretically required for full hydration of the concrete, as well as at water levels which are in excess of that theoretically required for hydration.

A problem with existing concrete preparation and pour processes is the risk taken when a pour is done in less than optimum conditions. As indicated infra, relative humidity, wind speed and temperature, among other environmental factors, routinely compromise standard pours because of their effect on the water levels at various locations on and within the concrete. This can occur even when the amount of water included complies with the recommended amount of water specified by the cement manufacturer, whether it is a recommended range of values or a single specified optimum value. The present invention enables the operation at the cement manufacturer's suggested water contents with a reduced risk of water-related issues. These suggested values generally correspond to the amount of water which would be required to enable the hydration reaction to proceed to an acceptable degree, or in some cases, to completion. In the practice of this invention, use of water in the amounts specified by the cement manufacturer is preferred. However, the present invention also reduces the risk of water issues with respect to other processes even when the water content deviates from that specified by the manufacturer. Thus, in some embodiments, the water content is within the range of from about −30% of the lowest value specified by the manufacturer specifications and +30% of the greatest value specified by the manufacturer specifications, based upon the weight of the water added to the cement before the addition of the colloidal amorphous or other silica described herein.

Yet another benefit of the present invention follows from the ability of formulations thereof to retain water for the benefit of extended hydration without the formation of capillaries and void reservoirs. It is known in the art that the addition of aggregate, sand and other commonly included bulking and strengthening materials to cement to form concrete generally require additional water to accommodate them in the concrete and can actually promote the formation of capillaries and, especially, void reservoirs. Such reservoirs are associated with and located in relation to the surfaces of the included materials. In general, the most preferred aggregates and materials are of a quality such that they associate closely with the concrete over their surface areas such that during hydration, reservoir formation is minimized, as is the associated loss of compressive strength. However, such high-quality included materials are generally uneconomical. Surprisingly, even in the presence of aggregates, the inclusion of amorphous silica particles can reduce or prevent the formation of void reservoirs and capillaries. Without desiring to be bound by theory, the reduction of such imperfections, particularly void reservoirs, and the associated increase in compressive strength, tends to indicate that the high surface area amorphous silica particles are participating in a direct association with the included material, regardless of material suboptimal quality. This association may exclude water and strengthen the attachment of the concrete to the included material.

Yet another benefit of the present invention is that concrete formulations prepared thereof can be pourable and/or workable without the use of so-called “superplasticizers”. Non-limiting examples of such superplasticizers include ligninsulfonate, sulfonated naphthalene formaldehyde polycondensates, sulfonated melamine formaldehyde polycondensates, polycarboxylate ethers and other superplasticizer components whether they are emulsions, dispersions, powders or other chemical forms. In one embodiment, the concrete formulations of the present invention are pourable without the inclusion of supplementary cementitious materials (SCMs) or admixture chemicals, including water-reducers or superplasticizers, and are superplasticizer-free or essentially superplasticizer-free. By “essentially superplasticizer-free”, it is meant that the superplasticizer content is in trace amounts of less than about 0.1% based upon the weight of the cement.

Below is a non-limiting list of admixtures which can be used with the present invention. Alternatively, the concrete mixture of the present invention can be free of any or all of the below additives or other additives. The list below is ordered as per ASTM C 494 categories. Included are admixtures that are certified and not certified by ASTM C-494.

Admixtures can be added as a powder or liquid.
Normal water reducers and retarders (Type A, B, D)
Nominal dosage range: 0.5-6 OZ/C
Super-Plasticizers: Normal setting and retarding (Type F, G)
Nominal dosage range: 2-40 OZ/C
Accelerating Admixtures: water-reducing or non-water-reducing (Type C, E)
Nominal dosage range: 2-45 OZ/C
Type S admixtures as defined in ASTM C 494:
   Mid-Range water-reducers and retarders
      Nominal dosage range: 2-45 OZ/C
   Corrosion inhibitors
Nominal dosage range: 0.25-5 GAL/YD
MVRA (Moisture vapor-reducing admixtures)
Nominal dosage range: 5-24 OZ/C
SRA (Shrinkage-reducing admixtures)
Nominal dosage range: 0.25-5 GAL/YD
Hydration stabilizers
Nominal dosage range: 0.5-24 OZ/C
Viscosity modifiers
Nominal dosage range: 0.25-8 OZ/C
Air-entraining admixtures;
Nominal dosage range: OZ as needed to entrain air: 0.1-36 OZ/C
Color agents; Liquid and solid
Nominal dosage range: 0.1-20 LB/YD

### Example 1

Location: Shelbyville, Ind. at the Shelby Materials ready-mix plant.

Environmental Conditions: The start time of the pour was 07:30 AM with a starting temperature of approximately 60° F. The ambient temperature peaked in the high 80's during the day. The relative humidity ranged from 18% to 67%. The wind speed range was from 3 to 13 mph.

Steps and Results:

1—A traditional class A concrete design of 6 bags (564 lbs) cement to 31 gallons of water (SSD—Saturated Surface Dry) per cubic yard (9 yards total) was used to place a 4-inch thick interior concrete slab with a non-air-entrained concrete. Roughly 12 gallons of water per cubic yard was added to the Ready-mix, followed by the dry cement mix (564 lbs per yard) as well as the aggregate and sand (1250 lbs of sand, and 1750 lbs of Stone per yard). The water and dry components were mixed for 1-2 minutes, and roughly 19 gallons of additional water per yard was then added to the Ready-mix. The mixture was mixed (in a concrete drum that has a high speed of 12-15 rpm for mixing of the concrete) for an additional time of 5-10 Minutes. When the driver was ready to transport the concrete to the job location he then slowed the concrete barrel to 3-5 rpm.

2—380.7 total ounces of E5 INTERNAL CURE (7.5 ounce/100 lbs cement) were then added after the 9 yards loaded and batched. Again, there were 564 lbs cement and 31 gallons of water per cubic yard.

3—The team allowed the ready-mix driver to mix the batch for 5 minutes at 12-15 rpm.

4—The ready-mix was then slowed to 2-5 rpm and driven 15 minutes to the job site. The concrete was then poured into the slab forms. The slab located against a metal building.

5—The traditional finishing process took place. After the pour, the slab was leveled. A bull float was then used to close the surface. Once the surface is hard enough to begin the mechanical finishing process appropriate methods used widely in the art were used to complete the finishing.

6—During the bull floating process, it was noted that the concrete was much easier to close than that of a traditional ready-mix process.

7—During the finish process where bleed water is generally present, this process presented no bleed water. However, the surface remained moist. The team speculated that unlike concrete prepared from traditional ready-mix products, the water, surprisingly, was retained within the concrete surface under conditions which would, with ready-mixes in the absence of E5 INTERNAL CURE, likely give a much drier surface.

8—The team then spent 4 hours completing the concrete finishing process. Unlike concrete prepared from traditional Ready-mixes, the finishing process could be performed with the machines running at half throttle because of the moisture still present at the concrete surface. This lead to a much easier finishing process. Traditional concrete requires machines to be run at a throttle of 100% and is a more labor-intensive process involving an increased risk of surface damage during finishing.

9—The team also noted that the internal thermal temperature swing was in excess of 50° F. In fact, because the pour was located against a metal building, the internal concrete temperature swing as measured by internal sensors was from a daytime high of 145° F. to a night time low 70° F. In the experience of the team, these temperature swings would be expected to result in significant cracking of the concrete during curing (see 10, below). In the vast experience of the team, thermal temperatures are generally one of the greatest accelerators to the evaporation of moisture at the surface of concrete. The day of this pour the team noticed that the moisture remained at the surface and seemed relatively unaffected by the thermal temperature swings. The team knew such behavior was entirely different than that of traditional poured concrete and could be extremely useful in the industry.

10—In the experience of the team, traditional concrete would normally require saw cutting within 24 hours of the pour. However, the team did not saw cut because of the increased amount of water clearly retained in the upper surface of the concrete and the likelihood that as a result, the shrinkage timing (time over which shrinking would normally occur) would be decreased and likely reduce cracking. Therefore, the concrete slab was allowed to remain undisturbed so that the team could determine how long it would take for the slab to internally release. To the surprise of the team, the slab did not internally release itself for 10 days. It should be noted that there were significant environmental changes such as temperature and rain. Without desiring to be bound by theory, the team surmised that the addition of E5 INTERNAL CURE was causing much of the water to be retained, likely through chemical association with the amorphous silica in E5 INTERNAL CURE, rather than lost through evaporation. It is further surmised that much of the retained water ultimately participated in hydration to give internal curing. The retention of water through chemical association with amorphous silica in E5 INTERNAL CURE (added to concrete prior to pouring, such as, for example to the Ready-mix truck), to be later incorporated through hydration (internal curing), has not been observed before, as can best be determined by the team.

### Example 2

This was done to ensure consistency in the performance of the product and to understand the process for maximum effect of internal cure.

Location: Beach Grove, Ind. at the Shelby Materials ready-mix plant

Timeframe: poured between 08:30 am and 09:35 am.

Environmental Conditions: 79° F., relative humidity ranged from 61% to 93%, cloudy and wind speed ranged from 6.9 to 12.7 mph.

Steps and Results:

1—The concrete for two samples was 5.5 bags (517 lbs) of cement, 0.5 water to cement ratio (31 gallons of water (SSD—Saturated Surface Dry) non-air entrained, 5.5 inch slump (517 lbs. of cement, 1225 lbs. of Sand, and 1800 lbs. of Stone per yard). The finishing process was the same as that of Example 1.

2—Sample 1 was poured as a reference. Sample 1 was done and placed as a 4″ thick slab. The concrete slab was also cured by applying plastic sheeting on top of the slab for 7 days as recommended by the American Concrete Institute (ACI). The compressive strength was measured 7 days after pouring to be 5760 psi.

3—Sample 2 was poured as with Sample 1, but with the addition, after mixing of cement, aggregate and sand, (517 lbs. of cement, 1225 lbs. of Sand, and 1800 lbs. of Stone per yard) of E5 INTERNAL CURE (3.5 oz per 100 lbs. of cement). It was cured as Sample 1. 7 days after pouring, the compressive strength was measured to be 6580 psi. The difference between sample 1 and 2 (with E5 INTERNAL CURE) was a 14% increase in strength.

4—The team of professionals then did a 28-day strength test as recommended by ACI (American Concrete Institute) to further support the idea that E5 INTERNAL CURE promoted internal curing, thus chemically binding the water to the concrete. The 28-day test results were as follows: Reference compressive strength: 6910 psi. Compressive strength when E5 INTERNAL CURE is included in the poured concrete: 8040 psi. The E5 INTERNAL CURE increases the compressive strength psi by 16%.

### Example 3

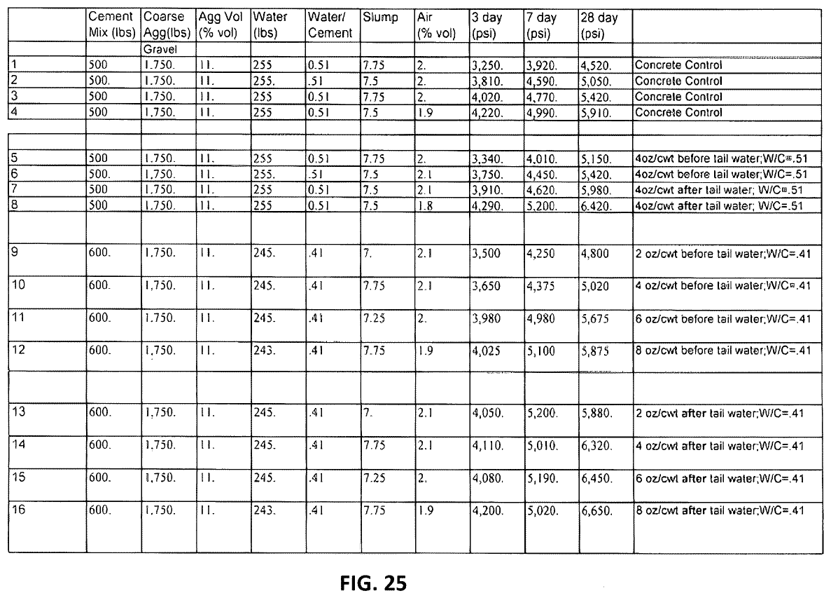

Sixteen industrial-scale batches of concrete were prepared. Cylinders from each sample were taken and tested for compression strength in accordance with ASTM C-39, at 3, 7 and 28 days. All samples included 1350 lbs sand. For all samples, the Ready-mix was driven an average of 20 minutes to the job site, and concrete test cylinders were then poured in accordance with ASTM C-39. The results are given in the table shown in FIG. 25.

The first group of four (samples 1-4), the “Concrete Control” group, are prepared without the addition of colloidal silica. Water/Cement ratio of 0.51. They were prepared by adding roughly 40% of the indicated water to a Ready-mix which was rotating at 2-5 rpm, followed by the addition of the total indicated quantities of cement mix, aggregate and sand. The aggregate in all samples in the study was (¾″ #8 ASTM C-33 #8 INDOT approved) gravel. The water and dry components were mixed for 1-2 minutes, which includes the time it took to add the components to the Ready-mix drum. The remaining water (approximately 60% of the water indicated) was then added to the Ready-mix. The mixture was mixed in a concrete drum that has a high speed of 12-15 RPMs for mixing of the concrete) for an additional time of 5-10 Minutes. When the driver was ready to transport the concrete to the job location, he then slowed the concrete barrel to 3-5 RPMs. The Ready-mix was driven to the job site, and concrete test cylinders were then poured in accordance with ASTM C-39.

The second group of four (Samples 5-8) are prepared with the addition of 4 oz of a colloidal silica solution (E5 Internal Cure: approximately 15 wt % silica, average particle size of less than 10 nm, with a BET surface area of approximately 550 m2/g, and 85 wt % water) per hundredweight cement (cwt).

The procedure for samples 7 and 8 (4 oz/cwt after tail water) is the same as for samples 1-4, but, additionally, 4 oz/cwt E5 Internal Cure were then added after the barrel was slowed to 3-5 rpm. The Ready-mix mixed the batch for about 5 minutes at 12-20 rpm. The Ready-mix was slowed to 3-5 rpm and driven to the job site, and concrete test cylinders were then poured in accordance with ASTM C-39.

The procedure for samples 5 and 6 (4 oz/cwt before tail water) was as for samples 1-4, except that E5 Internal Cure was included in the initial concrete mix, and the order of addition was cement mix, aggregate/sand, 4 oz/cwt E5 Internal Cure, 40% of water.

The procedure for Samples 9-12 (2, 4, 6 and 8 oz/E5 Internal Cure/cwt before tail water; W/C=0.41) is the same as that for Samples 6 and 7. Note that the amount of E5 Internal Cure increases for each sample, and the water/cement ratio is not 0.51, as with samples 1-8, but 0.41.

The procedure for Samples 13-16 (2, 4, 6 and 8 oz/E5 Internal Cure/cwt after tail water; W/C=0.41) is the same as that for Samples 7 and 8. Note that the amount of E5 Internal Cure increases for each sample, and the water/cement ratio is not 0.51, as with samples 1-8, but 0.41.

For each sample, the compressive strength was measured from cylinders aged to 3, 7 and 28 days. Note that the compressive strength measured for groups of similar samples (1-4; 5 and 6; 7 and 8; 9-12; 13-16) reflect a natural spread which is the result of variations in many factors which prevent the samples from being perfectly identical. The samples are ordered in order of ascending compressive strength only for convenience.

In every case in which the silica was added after the tailwater, the concrete showed little, if any bleed water, curling, cracking or shrinkage. The same amount of silica added prior to the water gave a concrete which had a bleed water amount which was similar to the control, or in some cases, worse than the control. The foregoing held true for both water/cement ratios (0.51 and 0.41). The compressive strength generally showed an increase with the use of the silica, with more silica giving a higher increase in compressive strength. However, the post-tail water addition gave a significantly larger increase than the pre-water addition of the silica. This advantage is in addition to the earlier-noted advantage of greatly reduced bleed water and curling cracking and shrinkage. Without desiring to be bound by theory, it is thought that the silica, when added after the water has been mixed with the other dry components, can reduce the water evaporation from the upper layers more efficiently than if it is added to the dry components prior to the water, or possibly even to insufficiently mixed concrete mix which contains water. Thus, the examples above illustrate that adding the silica to a well-mixed and wetted (or nearly fully wetted) concrete mix, particularly after the addition of the tailwater, unexpectedly gives an unexpectedly large improvement in compressive strength, as well as less or no bleed water, and fewer or no defects associated with high evaporation from the exposed upper surface of the curing concrete.

In an embodiment, a process is provided for the preparation of a body of concrete, such as in a cement truck drum. Understanding the foregoing chemical discussion, the process, from the standpoint of a dispensing plant or the like, entails receiving the concrete truck at the dispensing plant, and then dispensing specified products into the drum of the truck while the drum is rotating at a speed between about 12 rpm and about 20 rpm. The dispensed products comprising dry cement, with a manufacturer suggested water/cement ratio value in the range of from about 3.5 to about 6.5, an amount of water, an amount of aggregate and/or sand in the range of from about 400 to about 700 wt % bwoc and a quantity of amorphous silica. The amorphous silica is in the range of from about 0.1 to about 7.0 ounces per hundredweight of cement, with an average silica particle size in the range of from 1 to 55 nanometers (and/or with the surface area of the silica particles being in the range of from about 300 to about 900 m.sup.2/g).

The water includes a tailwater portion, and the amorphous silica and the tailwater are added to the drum after mixing of the dry cement, aggregate and/or sand and the water (excluding the tail water). The final mix so formed is then further mixed to intercombine the tailwater and the amorphous silica and form the body of concrete.

It will be appreciated given the foregoing that the process may instead be inverted, in the sense that the primary ingredients may be mixed in the plant rather than in the truck, e.g., at a wet batch facility. In this case, the tail water and amorphous silicon are added to the empty drum, and the pre-mixed primary ingredients then added thereto. The important aspect in both scenarios is that the mix, excluding any tail water and the amorphous silica, be fully mixed and wetted (or nearly fully wetted) prior to the addition of (or prior to being added to) the tail water and the amorphous silica.

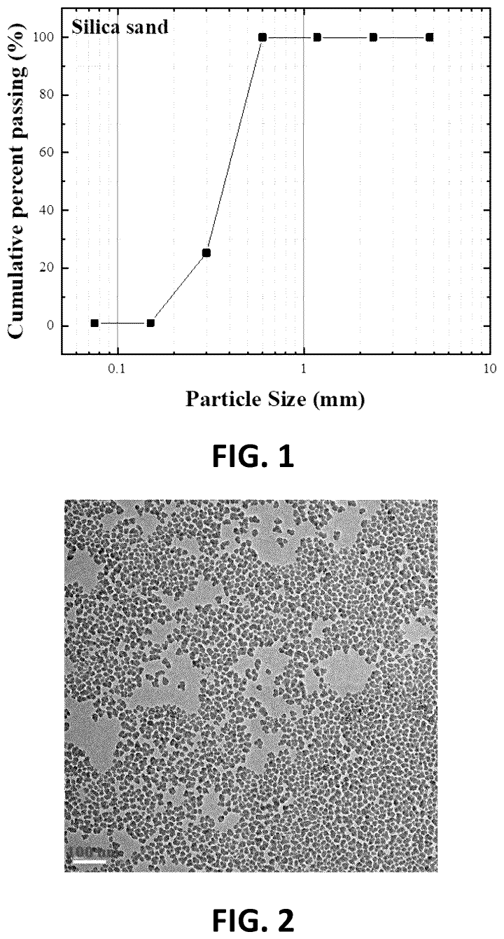

In the studies referenced herein, a series of nanosilica-based strain-hardening cementitous composites (SHCC) experiments were performed. Four different mixes were conducted using ordinary Portland cement (OPC), class C—fly ash (FA), silica sand, PVA fiber, and colloidal nanosilica (CNS). The PVA fiber has the diameter of 0.39 mm and length of 8 mm. The fiber additional rate was kept as 1% volume friction for all mixtures. The particle size distribution is shown in FIG. 1. To ensure the interfacial friction between the mixture and fiber, the methylpentane based viscosity-modifying admixture (MasterMatrix VMA 450, BASF) was added, and the ratio was kept at 1% by weight of cementitious materials to maintain the performance. The addition rate of colloidal nanosilica (E5® Internal Cure®, Specification Product, Inc.) was varied from 0% (as reference group) to 1% by weight cement in SHCC.

FIG. 2 reveals the image of nanosilica obtained from transmission electron microscopy (TEM). The composition of SHCC is shown in Table 1. The water to binder ratio was kept constants for all the mixes at 0.35. As noted herein, the lower volume of PVA fiber and the relatively higher water-to-binder ratio compared with previous studies available in the literature reduces the overall cost and achieves practical applicability.

TABLE 1
Composition of SHCC with colloidal
nanosilica (by cement weight)

| | | | Silica | | | PVA | |
|---|---|---|---|---|---|---|---|
| Mix | OPC | FA | sand | CNS* | VMA* | fiber^{$} | W/B† |
| REF | 1 | 0.5 | 0.8 | 0% | 1% | 1% | 0.35 |
| 0.3% | 1 | 0.5 | 0.8 | 0.3% | 1% | 1% | 0.35 |
| E5 CNS | | | | | | | |
| 0.6% | 1 | 0.5 | 0.8 | 0.6% | 1% | 1% | 0.35 |
| E5 CNS | | | | | | | |
| 1.0% | 1 | 0.5 | 0.8 | 1.0% | 1% | 1% | 0.35 |
| E5 CNS | | | | | | | |

*By weight percent of cement;
^{$}By volume percent;
†Water-to-binder ratio

During the mixing, the dry powder form materials (OPC, FA, silica sand) were mixed for 3 minutes. Half of the water was added first for the wet mix. Another half of the water was mixed with VMA and added for mixing 3 minutes. PVA fibers were added after the mortar was ready and mixed for another 2 minutes. The liquid colloidal nanosilica was added last as the manufacturer suggested and mixed for 2 more minutes. The SHCC was cast into the mold and covered with a plastic sheet at 23° C. laboratory environment for 24 hours. After one day, the specimens were demolded and placed in the curing chamber (23° C., 50% relative humidity (RH)) until the testing age.

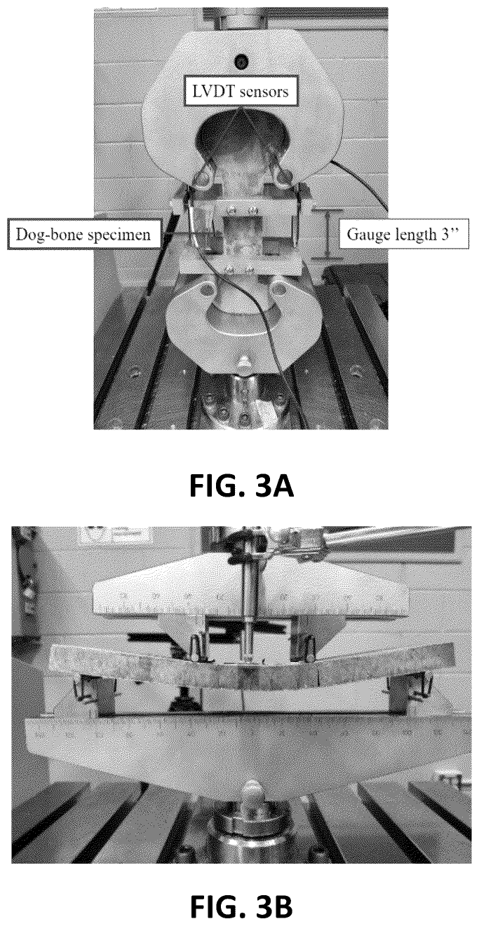

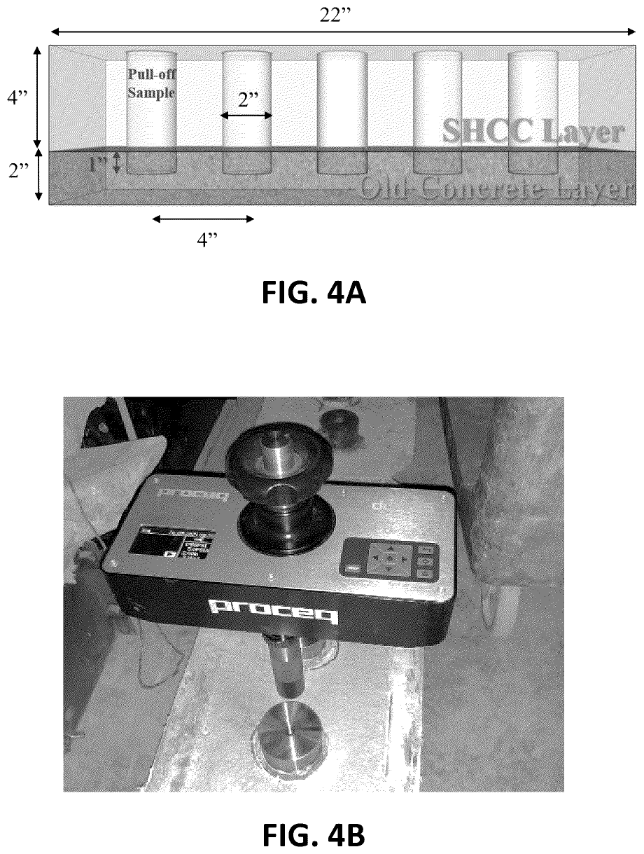

Various experiments were conducted to evaluate the mechanical properties of nanosilica-based SHCC. The 50 mm cubic specimens were prepared for compressive testing per ASTM C109. The direct tensile testing was performed using dog-bone specimens with a thickness of 12.7 mm (0.5 in) and width of 50.8 mm (2 in). The gauge length of the dog-bone sample is 76.2 mm (3 in), and two LVDTs were installed at two sides of the specimen to measure the displacement, as shown in FIG. 3A. The tensile loading rate was controlled at 0.5 mm/min to simulate the quasi-static loading condition. The flexural performance of the SHCC was evaluated through four points bending test with 240 mm×60 mm×15 mm plate specimens (FIG. 3B). The testing ages were seven days and twenty-eight days. In addition, four shrinkage bars were also prepared for each SHCC set to assess its drying shrinkage behavior. The drying shrinkage of the SHCC was monitored from 3 days to 120 days per ASTM C596. To understand the interfacial bonding properties between the new cast SHCC and the old concrete layer, the pull-off test (ASTM C1583) was conducted. The dimension of the pull-off sample is presented in FIG. 4A. The two inches concrete layer was cast and cured for 35 days, and then, four inches SHCC layer was poured and cured for 28 days. Five pull-off core specimens (2″ in diameter) were drilled, as shown in FIG. 4A. The pull-off testers (Proceq DY-225, FIG. 4B) were used for measuring the bonding strength with the pulling rate of 5 psi/s at each age of interest.

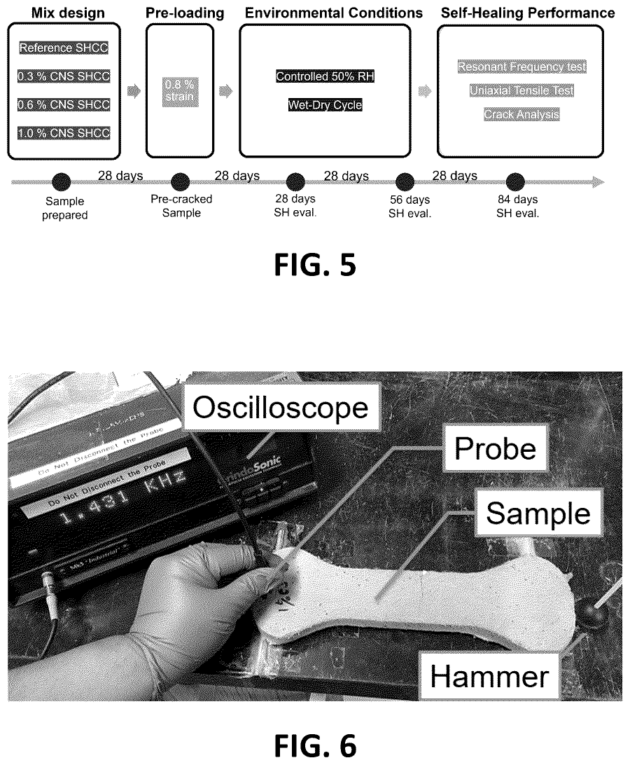

To investigate the self-healing performance of SHCC, the dog bone samples were prepared for conducting the resonant frequency test and post-direct tensile test. The procedure for evaluating the self-healing performance of the colloidal nanosilica-based SHCC specimens is shown in FIG. 5. The resonant frequency of intact SHCC dog bone samples was first measured per ASTM C215 as shown in FIG. 6. Then, the samples were preloaded through uniaxial tensile loading with the pre-strain level of 0.8% and measurements of the resonant frequency of pre-cracked samples were taken as the baseline. The pre-cracked SHCC specimen were placed in two types of environmental conditions for assessing the self-healing performance, including wet-dry cycles (altered between immersed in water for 48 hrs and placed in 50% RH for 48 hrs) and 50% RH dry cure in chamber with the controlled temperature of 23±2° C. and humidity of 50±5% RH. The wet-dry cycles condition simulates the sunny day and rainy day, and the controlled 50% RH condition considers the extreme condition of low humidity level. The self-healing evaluation was measured at 28 days (one month), 56 days (two months), and 84 days (three months) using both resonant frequency test and tensile re-loading test. The condition of the cracks was monitored through digital microscopy every two to four wet-dry cycles to evaluate the crack sealing performance of each sample. To further understand the hydration condition of the samples at each age, thermogravimetric analysis (TGA) and SEM were carried out.

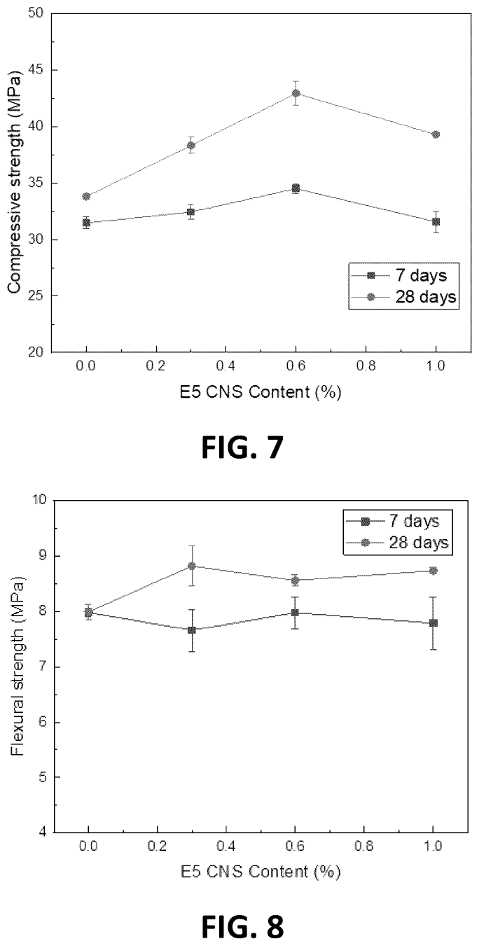

The compressive strength results of colloidal nanosilica-based SHCC are presented in FIG. 7. It can be seen that for the early age (7 days), the compressive strength of four types of SHCC was higher than 30 MPa. Among the four sets, SHCC with 0.6% E5 colloidal nanosilica showed highest compressive strength results of around 34 MPa. It is apparent from this figure that the 0.6% E5-SHCC shown the highest compressive strength of over 43 MPa compared with others at the age of 28 days. Quantitatively speaking, the addition of colloidal nanosilica increases of 28-days compressive strength of SHCC by approximately 13% to 27% depended on the additional rate. The improvement of compressive strength of SHCC could be attributed to both pozzolanic reaction and the filler effect of colloidal nanosilica. E5® CNS would react with the hydration by-product —Ca(OH)₂ and synthesize C-S-H gel. Further, the nano particle has the ability to fill the voids and densify the cement matrix of SHCC. Nevertheless, it had indicated that as the amount of CNS increased, the compressive strength of SHCC decreased. It might be due to the fact that excessive nanosilica resulted in agglomeration of nano particles which has an adverse effect on the microstructure of SHCC.

FIG. 8 shows the results of the four-point bending test. It can be observed that the results of 7 days strength did not show a significant difference for SHCC with various CNS dosages. The results of 28 days strength indicate that SHCC with colloidal nanosilica presents higher flexural strength than the reference set for 7 to 9%. The addition of CNS enhances the densification of the interfacial transition zone (ITZ) between SHCC matrix and PVA fiber, leading to higher ultimate flexural strength.

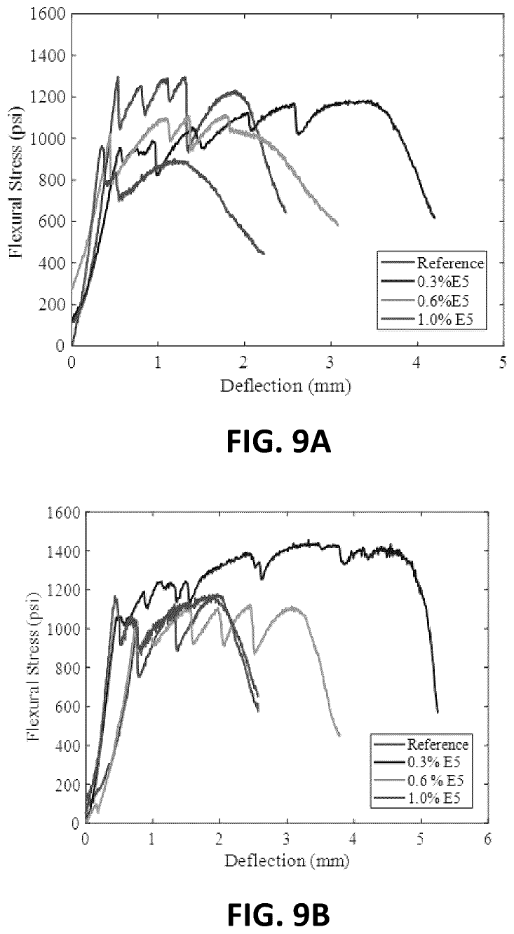

The flexural stress performance of the representative SHCC samples is shown in FIG. 9. It can be seen from the figure that SHCC samples for both 7-days (FIG. 9A) and 28-days (FIG. 9B) exhibit pseudo strain-hardening behavior. Among different samples, 0.3% E5-SHCC display better flexural capacity. Nevertheless, the increase of CNS would not enhance the flexural capacity of SHCC as 1.0% E5-SHCC demonstrated. To evaluate the ductility of each SHCC sample, it has calculated the index of each sample for comparison.

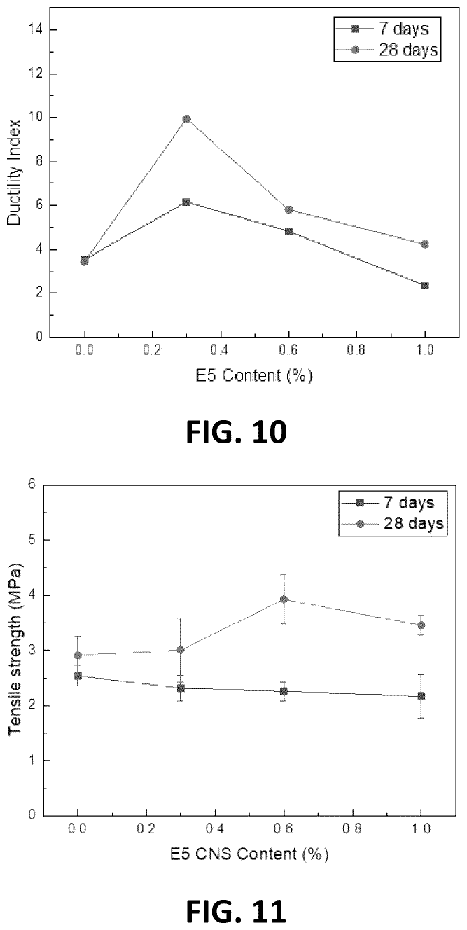

FIG. 10 indicates the calculation of the ductility index for the SHCC sample. The ductility index is defined as the ratio between the strain on the modulus of rupture (MOR) and the strain on a limit of proportionality (LOP), i.e. (Ductility index=δ_{MOR}/δ_{LOP}). This index can be used to determine the degree of ductility of the materials behaved strain-hardening property. As the figure shows, SHCC with nano-silica incorporation presents higher ductility than the reference set. It can be seen that 0.3%-E5 SHCC presents the highest ductility, which might be the optimized CNS dosage to enhance the interfacial properties between matrix and fiber. Based on previous studies, it has to satisfy two micromechanics criteria—cracking energy and strength, to achieve the strain-hardening behavior. The SHCC matrix with 0.3% E5 CNS successfully optimized the fiber bridging strength stress to be larger than the stress across the crack tip. Thus, it required more energy to de-bond the fiber and resulted in a higher flexural capacity. However, the extra CNS would not benefit the ductility performance of SHCC.

The ultimate tensile strength results of SHCC samples are shown in FIG. 11. It can be seen that the strength results at the age of 7 days did not show a significant difference (if considered the error bar) for four mixtures with various dosages of E5 CNS. Nevertheless, at the age of 28 days, the colloidal nanosilica-based SHCC show higher tensile strength results; specifically, for SHCC with 0.6% and 1.0% nanosilica, the tensile strength results are higher than 3.5 MPa. However, compared with 0.6% CNS-based SHCC, the increase of CNS adversely affects the 28-days tensile strength in a manner similar to the compressive strength results.

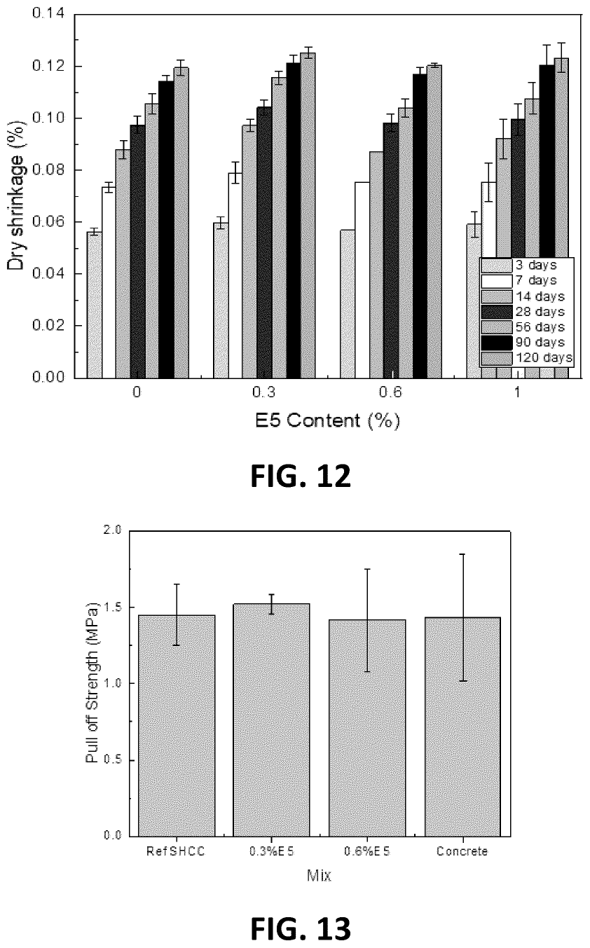

The drying shrinkage results of four SHCC mixes from 3 days to 90 days are shown in FIG. 12. As the figure indicates, the early age shrinkage of SHCC was located at around 0.05% to 0.06% for 3 days and 0.07% to 0.08% for 7 days. The increase of the drying shrinkage tends to slow down after 28 days. It is hard to observe the correlation between drying shrinkage and colloidal nanosilica content since the results of each set did not have a significant difference if considering the error bar. The reason might be due to the existence of PVA fiber or other fiber reinforcement materials, which dominated the control of drying shrinkage, therefore the shrinkage could hardly be affected by the addition of colloidal nanosilica in SHCC. It is worth noting that the variability of 1% E5 SHCC is significantly higher than other sets, which might be due to the negative effect of excessive CNS.

To evaluate the bond strength between SHCC and concrete, pull-off testing was performed. The 2-inch concrete layer was prepared and cured for 35 days as substrate. Four types of sample configurations were prepared including concrete-to-concrete SHCC-to-concrete (reference SHCC-to-concrete, 0.3% E5® CNS-SHCC-to-concrete, and 0.6% E5 CNS-SHCC-to-concrete). The thickness of the upper layer (SHCC) is 4 inches, while the bottom old concrete layer is 2 inches. The pull-off testing was conducted after 28 days of the casting of the upper layer. FIG. 13 reveals the results of bonding strength for different types of upper layers. The pull-out strength of each sample is higher than 1.38 MPa (200 psi). It can be observed that the bonding strength did not show a significant difference between different types of the upper layer. It is also worth noting that coarse aggregates mainly contribute to the interlock properties in the concrete; nevertheless, even with coarse aggregates incorporated in SHCC mix design, it has still shown comparable bonding strength with concrete.

Several experiments were conducted to assess the self-healing performance of SHCC with various dosages of colloidal nanosilica, including resonant frequency test, direct tensile test, and microscope cracks analysis. Furthermore, SEM and TGA were performed to understand the morphology and hydration degree after self-healing.

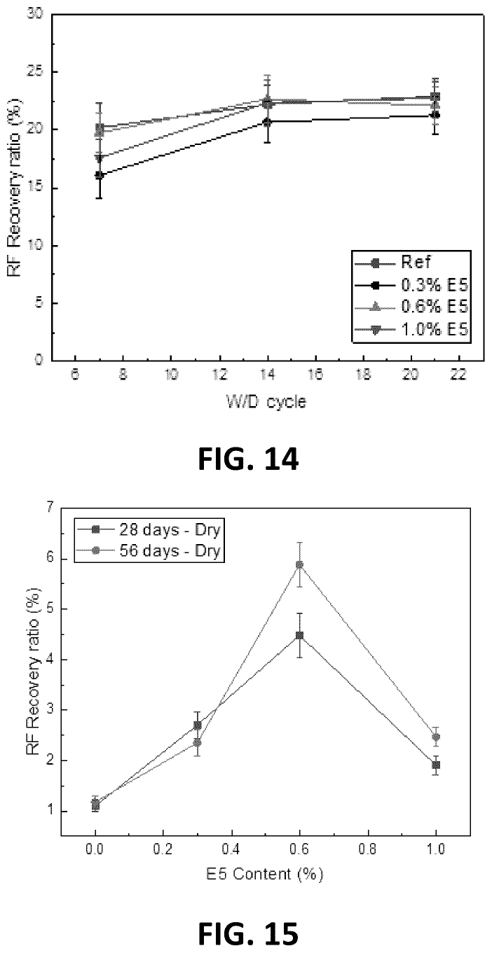

A resonant frequency test was performed per ASTM C215 to evaluate the self-healing performance of SHCC samples. The results are shown in FIG. 14. As it can be seen that under the wet/dry cycle condition, the RF recovery ratio of reference SHCC is higher than SHCC with E5 CNS at early cycles (7-cycles). This might be due to the fact that the reference sample (without colloidal nanosilica incorporated) remained more unhydrated. On the other hand, nanosilica with the high surface-area-to-volume ratio increases chemical reactivity during hydration of cementitious materials; thus, the higher portion of cement particles was consumed at its early stage. However, after 14 cycles (56 days), the CNS based SHCC gradually caught up in the RF recovery ratio, especially for SHCC samples with a higher dosage of colloidal nanosilica (i.e., 0.6% and 1%). Among three sets of colloidal nanosilica based SHCC, the sample with 0.6% CNS showed a higher recovery ratio than the other sets.

FIG. 15 reveals the results of the resonant frequency recovery ratio for the sample under the dry condition. As the figure illustrates, SHCC sample with CNS incorporated presents a higher RF recovery ratio, particularly, 0.6% E5-SHCC showed the highest recovery ratio than other samples.

One of the possible assumptions is attributed to the “water holding effect” of the colloidal nanosilica floc network, which would be able to retain some water for long-term reaction even under low humidity environmental conditions. Previous literature indicated that once silica sol contacts with cement particles, they tend to gel instantly. The silica gel is a three-dimensional network that allows ions and water to slowly diffuse in and out of the system. Thus, the water evaporation of the CNS based SHCC was reduced and resulted in further hydration inside SHCC and a higher RF recovery ratio.

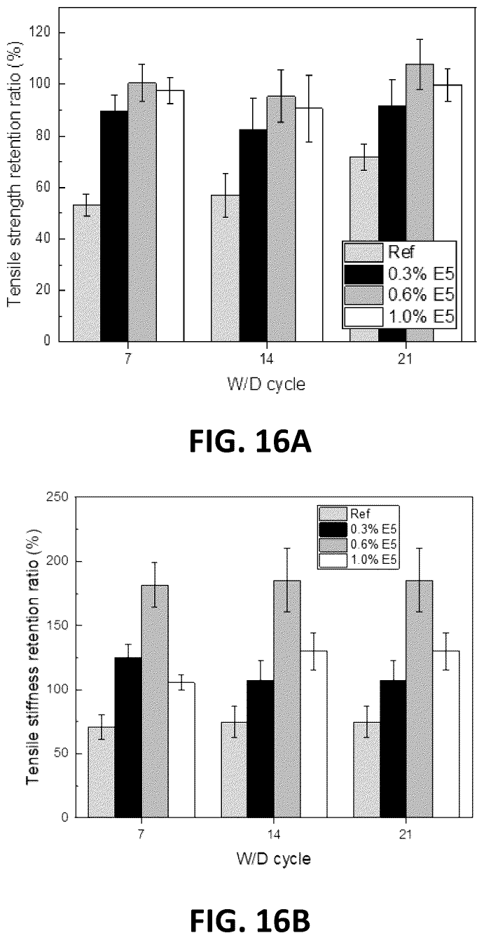

The pre-crack SHCC sample was exposed to two designated environmental conditions and re-loading at the age of interest. FIG. 16A and FIG. 16B illustrate the tensile strength retention ratio (FIG. 16A) and tensile stiffness retention ratio (FIG. 16B) of SHCC with various dosages of colloidal nanosilica after wetting/drying (W/D) cycles conditioning. The tensile strength and stiffness retention ratio was the proportion between maximum stress (σ)/stiffness (k) under pre-loading and re-loading conditions which is defined as σ_{re-loading} or k_{re-loading}/σ_{pre-loading} or k_{pre-loading} (%). It can be observed that the colloidal nanosilica-based SHCC samples performed a higher tensile strength retention ratio than the reference set. Specifically, 0.6% E5 and 1% E5 SHCC samples showed better tensile strength retention ratio of the value higher than 90% compared with other sets. This result echoes the mechanical testing results from the previous session. The reason might be attributable to the densification of the matrix with higher dosages of colloidal nanosilica which strengthens the ITZ between the SHCC matrix and the PVA fiber. FIG. 16B plots the results of the tensile stiffness retention ratio of SHCC samples. It is obvious that the SHCC sample with E5® CNS can reach higher tensile stiffness than the reference sample with a ratio of higher than 100%. The continued pozzolanic reaction during the W/D cycles period resulted in a finer C-S-H phase and densified the microstructures of colloidal nanosilica-based SHCC to achieve even higher stiffness compared with the sample before W/D cycle conditioning.

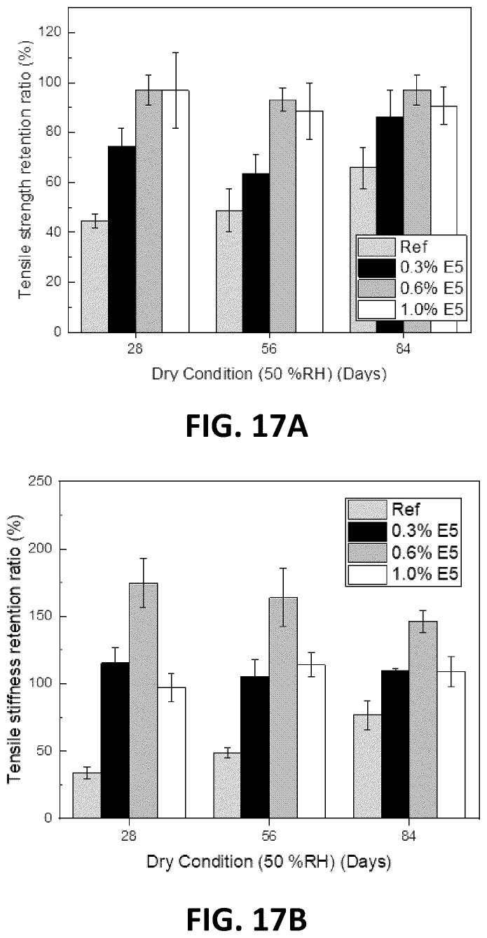

FIG. 17A and FIG. 17B exhibit the tensile strength and stiffness retentions ratio of SHCC samples under the controlled 50% RH conditions, respectively. It can be seen that even without the external water supply, the tensile performance of SHCC still grew over time. Specifically, for those samples with colloidal nanosilica incorporation, they performed an exceptional stiffness retention ratio as compared to the reference SHCC. Compared to two healing conditions, it is interesting that there is no significant difference between tensile strength (FIG. 16A and FIG. 17A) and stiffness (FIG. 16B and FIG. 17B) retention ratio for the samples under W/D cycle and dry condition. The reason might be that most fibers are not broken or pulled out under the pre-cracking level; hence, all the pre-cracked SHCC specimens are still able to show satisfactory retained tensile strength and stiffness.

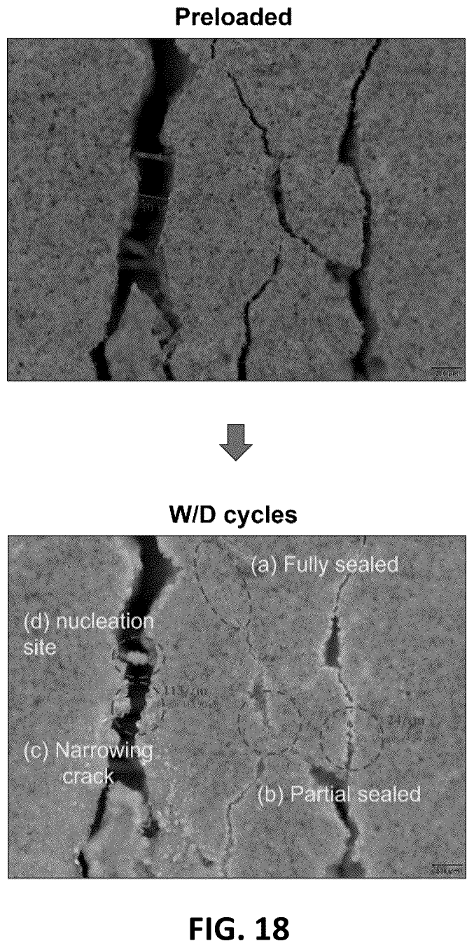

Observation of the SHCC sample was performed to compare the cracks after being exposed to designated environmental conditions. FIG. 18 compares microscopic images for the SHCC sample after preloading and several W/D cycles. In general, the condition of the W/D cycle was effective for interrogating the self-healing mechanism of the SHCC sample due to the supplying of water. For the cracks with a width less than about 30 μm, they were able to seal completely after two W/D cycles as (a) location in FIG. 18. It can be observed that the cracks were partially sealed with a width around 50 μm, as (b) spots indicated in the figure. Y. Yang et al. suggested that for crack widths larger than 150 μm, it can barely observe the autogenous healing of SHCC; however, we have observed the crack narrowing from 233 μm to 113 μm after two W/D cycles conditions as shown at the spot (c) in FIG. 18. As suggested by literature, the PVA fiber can be the nucleation site for growing the healing precipitants, which was also observed in this figure at (d) area.

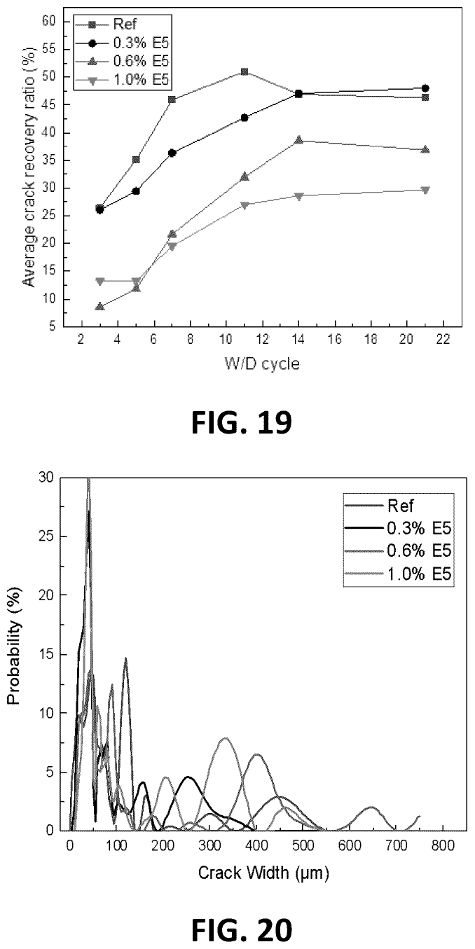

FIG. 19 illustrates the average crack recovery ratio after several W/D cycles for different SHCC samples. It can be seen that reference SHCC shows a higher average crack recovery ratio than colloidal nanosilica-based SHCC since Ref SHCC might leave less hydrated cementitious particles for further hydration. Also, crack sealing of Ref SHCC might be due primarily to the formation of calcite (CaCO₃) or re-crystallization of portlandite leached from the bulk paste, which can be more easily observed from the surface. On the other hand, it has been noticed that the 0.6% and 1% E5-SHCC showed a lower average crack recovery ratio compared with the 0.3% E5® sample and Ref-SHCC sample; it might be because the crack width of these samples was not favorable for healing. Y. Yang et al. found there is less recovery or no recovery for crack widths larger than 150 μm. Thus, if we look into the probability of the crack width for different samples as FIG. 20 shows, it can be found that the probability of a large width crack (larger than 150 μm) of 0.6% and 1% E5-SHCC is higher than the 0.3% E5® set and reference set. Specifically, in the crack width range of 300 μm to 400 μm, the probability for SHCC sample of 0.6% and 1% E5® mix is higher than 5%.

TGA was carried out to characterize the hydration condition of the SHCC specimens. It has taken the small pieces from the self-healed samples and ground them into powder-form that can pass a 75 μm (No. 200) sieve. Other than cementitious matrix, sand and PVA fibers were eliminated from the ground samples. The 2050 thermogravimetric analyzer (TA Instruments) was used to perform the measurement. It was set up with a heating rate of 10° C./min, and the temperature incremental started from ambient temperature (25±2° C.) up to 900° C. Previous studies have suggested that the chemically bound water (W_{b}) in the cementitious composite can be used to quantify the hydration of the cementitious materials. The chemically bound water was calculated based on the Equation (1) suggested by Monteagudo et al. as noted herein,

W_{b}(%)=Ldh+Ldx+0.41(Ldc−Ldcₐ) (1)

where Ldh, Ldx, Ldc denote the dehydration, dehydroxylation, and decarbonation of the hydrated compounds, respectively. Ldcₐ represents the decarbonation of the anhydrous materials. It has implemented the conversion factor of 0.41 to ensure that only the bonding water is considered in the calculation since the decarbonation process also generates carbon dioxide.

The calculation of the calcium hydroxide (CH) content was made according to the method proposed by Kim et al. In this method, the first and second derivative curves of the mass loss curve were used to quantify the amount of the CH, while the mass losses caused by other hydration products except CH and CaCO₃ were also considered to further eliminate the error.

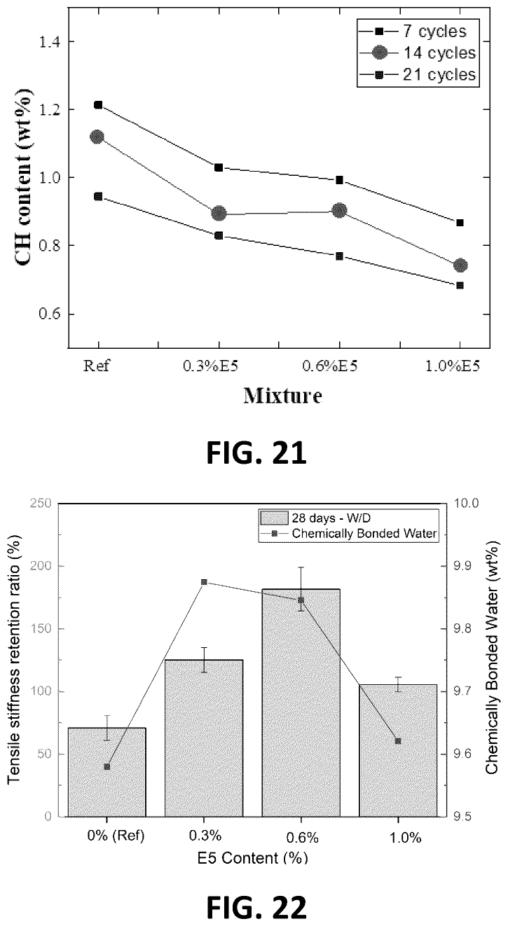

The calculated CH content of the tested samples are shown in FIG. 21. In general, the CH content of the samples decreased over time due to the pozzolanic reaction since a large amount of fly ash was used in the SHCC composition. The samples with colloidal nanosilica incorporation showed lower CH content than reference samples which indicated the colloidal nanosilica was able to consume more CH and enhance the pozzolanic reaction. FIG. 22 further combines the chemically bound water results and tensile stiffness retention results for comparison. It can be verified that the addition of colloidal nanosilica allowed SHCC to improve the hydration degree in the microscale and positively affected the bulk tensile property of the samples.

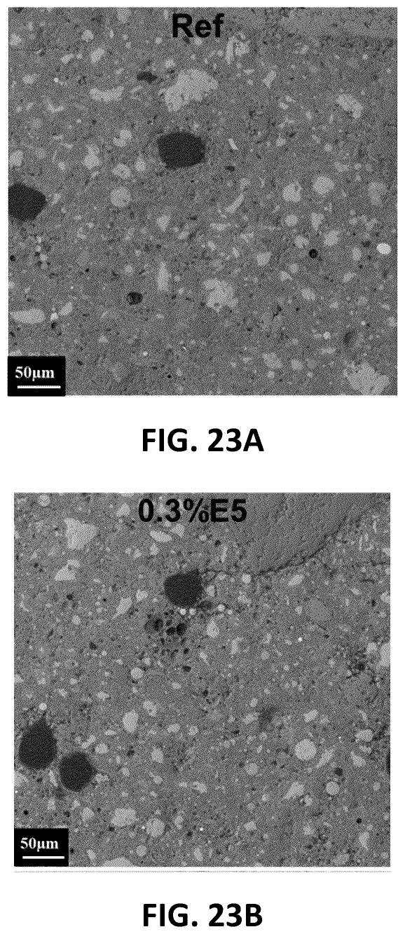

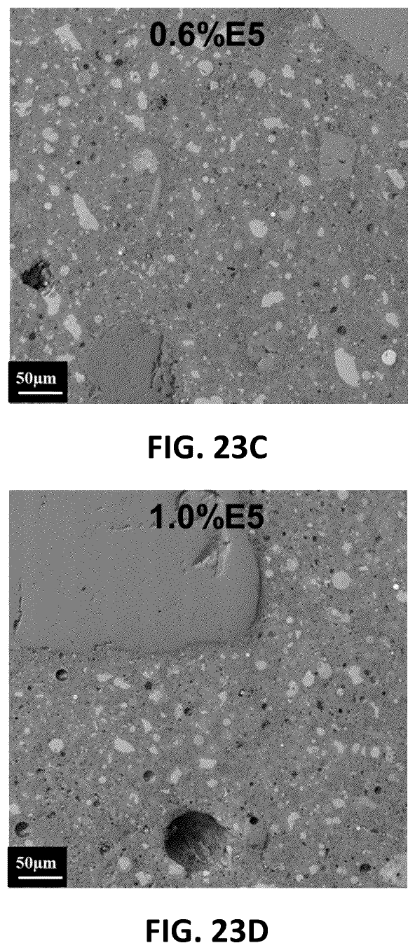

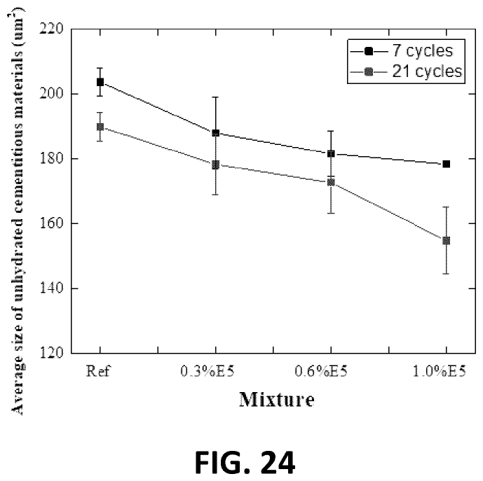

To understand the morphology and hydration condition of SHCC samples after the healing period, the SEM was studied. The surface of SHCC sample was coated with platinum to enhance the surface conductivity before SEM analysis, then the surface was observed by using a SEM. FIG. 23A, FIG. 23B, FIG. 23C, and FIG. 23D display the representative SEM images for different types of SHCC samples after 21 W/D cycles. In the SEM images, the components are identified based on the shapes and gray levels. The main area with grey color represents the cementitious paste, and the sand in the image appears as a shade of darker gray. The unhydrated cementitious particles are the brighter whitish grains. And the black sphere-shaped regions are the cross-section of the PVA fibers. From the SEM images, it can be observed that all the samples were well-hydrated, and the cementitious matrix was dense after the designed curing period. It is observed that the unhydrated cementitious particles were smaller when various dosages of the CNS were incorporated. This may be due to the internal curing effect, and the nano seeding effect of the CNS, which improved the hydration of the cementitious materials, which led to a higher hydration degree and smaller size of the unhydrated cementitious particles.

Afterward, the images were further analyzed through Image J software to identify the average size of unhydrated cementitious particles. More than five images were used for each data point for different conditions (7 cycles and 21 cycles). It can be observed that the average particle size of the unhydrated cementitious materials decreased with the increase of colloidal nanosilica content. Notably, the particles area of 1% E5 CNS-SHCC sample is smaller than 160 μm². This evidence further verifies the benefits of long-term hydration promotion of CNS in SHCC.

As referenced herein, the comprehensive mechanical properties and self-healing performance of colloidal nanosilica-based SHCC were investigated. For the mechanical properties, compressive testing, tensile testing, flexural testing, and pull-off testing were conducted at different ages of interest. A shrinkage bar test was also performed to monitor the drying shrinkage for up to 120 days. On the other hand, the self-healing performance was accessed through the non-destructive resonant frequency test and destructive post-tensile test. Microscopic imagines of SHCC samples after being exposed to designated environmental conditions were taken to analyze the condition of cracking. SEM and TGA were conducted for the quantification of the SHCC samples after the medium-term healing period.

The incorporation of colloidal silica can effectively improve the mechanical properties of SHCC. For compressive strength results, the CNS based SHCC can reach higher than 30 MPa at 7 days. With the incorporation of colloidal nanosilica, the compressive strength of SHC increased approximately 13% to 27%, depending on the additional rate. The flexural strength results indicate that SHCC with E5® colloidal nanosilica showed higher flexural strength than the reference set for 7 to 9%. The tensile results of SHCC suggest that the colloidal nanosilica-based SHCC show higher tensile strength results of the strength over 3.5 MPa (500 psi). Also, SHCC with colloidal nanosilica incorporation presents higher ductility than the reference set as reflected on the ductility index. Specifically, the additional ratio of 0.6% by weight of cement can achieve the best mechanical strength performance, which might be the optimal dosage.

The self-healing evaluation suggests that the SHCC with colloidal nanosilica incorporated presents a positive impact for autogenous healing of the pre-cracked sample. Resonant frequency test results indicated that under the W/D cycle condition, the RF recovery ratio of CNS based SHCC can recover 15% or above for 28 days. The tensile testing revealed that the SHCC sample with E5® CNS could reach higher tensile strength and stiffness retention ratio than reference SHCC sample. Based on the microscopic image analysis of cracks, all the SHCC has shown crack recovery after W/D cycle conditions (28 days). Specifically, 0.3% E5® can reach higher than 30%. However, the crack sealing of Ref SHCC might mainly be due to the formation of calcite (CaCO₃) or re-crystallization of portlandite leached from the bulk paste, which is mostly on the surface and easier to be observed by microscope. Therefore, the crack recovery ratio is higher than colloidal nanosilica-based SHCC.

The TGA analysis was performed to characterize the hydration condition of the SHCC specimens. The colloidal nanosilica-based SHCC had lower CH content than the reference set which suggested the nanosilica was able to consume more CH and enhance the pozzolanic reaction for the medium-term healing period. It has also been found that the chemically bound water calculation aligned with tensile stiffness retention results of the SHCC samples, which further ascertain that the addition of colloidal nanosilica positively affected the bulk tensile property of the samples.

Since the cost of the nano materials is challenging to make it practical, the studies referenced herein provided the insight of using a relatively small amount of the incorporation rate in the SHCC. The outcome of these studies suggested that small dosages of colloidal nanosilica can benefit not only the mechanical properties of SHCC but also the self-healing performance in the medium-term period. Meanwhile, more effort should be made to discuss the long-term durability and scaled-up performance of SHCC to approach the practical application in the future.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such as “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

1. A method for preparing a concrete mixture, comprising:
a) combining a quantity of dry cement, a first quantity of water, and a quantity of sand and/or aggregate and mixing the same until they are fully wetted or nearly fully wetted, forming a mixed and wetted combined product; and
b) adding a quantity of amorphous nanosilica to the mixed and wetted combined product and mixing the same to form a concrete mixture;
wherein the quantity of amorphous nanosilica is either i) added to the mixed and wetted combined product along with a second quantity of water, or ii) a colloidal nanosilica suspension that is added to the mixed and wetted combined product to form the concrete mixture.

2. The method of claim 1, wherein steps a) and b) are performed by mixing the quantity of dry cement, the first quantity of water, the quantity of sand and/or aggregate, and the quantity of amorphous nanosilica within a drum of a ready-mix concrete truck.

3. The method of claim 2, wherein the drum of the ready-mix concrete truck is rotating at or between about 12 rpm and 20 rpm.

4. The method of claim 1, wherein step a) is performed by also combining a quantity of fly ash with the quantity of dry cement, the first quantity of water, and the quantity of sand and/or aggregate to form the mixed and wetted combined product.

5. The method of claim 4, further comprising the step of:
combining a viscosity-modifying admixture with an additional quantity of water to form an admixture part; and
adding the admixture part to the mixed and wetted combined product prior to performing step b).

6. The method of claim 5, further comprising the step of:
adding a polyvinyl alcohol fiber or other fiber reinforcement material to the mixed and wetted combined product prior to performing step b).

7. The method of claim 6, wherein the concrete mixture can be poured and cured to form a hardened concrete product.

8. The method of claim 7, wherein a crack having a width of about 30 μm or less formed within the hardened concrete product can seal after exposing the hardened concrete product to at least two wet/dry cycles.

9. The method of claim 1, wherein the concrete mixture is formed without the use of a supplementary cementitious material, a water-reducer, a superplasticizer or other admixture chemical.

10. The method of claim 1, wherein the amorphous nanosilica is present in a range of about 0.1 ounces to about 50 ounces per 100 pounds of cement.

11. The method of claim 1, wherein the amorphous nanosilica has an average particle size in the range of about 1 nanometer to about 150 nanometers.

12. The method of claim 1, wherein the amorphous nanosilica has a surface area in the range of about 40 m²/g to about 1200 m²/g.

13. The method of claim 1, wherein the amorphous nanosilica is selected from the group consisting of colloidal nanosilica, precipitated silica, silica gel, and fumed silica.

14. The method of claim 1, wherein the amorphous nanosilica is provided as a colloidal nanosilica suspension comprising up to about 50 wt % amorphous silica.

15. The method of claim 1, wherein the amorphous nanosilica is provided as a colloidal nanosilica suspension comprising about 15 wt % amorphous silica in about 85 wt % water.

16. The method of claim 15, wherein the colloidal nanosilica suspension is present within the concrete in a range of about 0.1 ounce to about 20 ounces per 100 pounds of cement.

17. The method of claim 1, wherein the amorphous nanosilica has an alkaline pH above 7.

18. A concrete mixture, prepared by:
a) combining a quantity of dry cement, a first quantity of water, and a quantity of sand and/or aggregate and mixing the same until they are fully wetted or nearly fully wetted, forming a mixed and wetted combined product; and
b) adding an amorphous nanosilica to the mixed and wetted combined product and mixing the same to form a concrete mixture;

19. The concrete mixture of claim 18, wherein the amorphous nanosilica is added to the mixed and wetted combined product along with a second quantity of water.

20. The concrete mixture of claim 18, wherein the amorphous nanosilica is first combined with a second quantity of water to form a colloidal nanosilica suspension that is added to the mixed and wetted combined product to form the concrete mixture.
